(19) United States
(12) Patent Application Publication
(10) Pub. No.: US 2025/0219787 A1
(43) Pub. Date: Jul. 3, 2025

(54) METHOD AND APPARATUS FOR PRE-DFT RS AND DATA MULTIPLEXED DFT-S-OFDM WITH EXCESS-BAND-WIDTH SHAPING AND MIMO

(71) Applicant: WISIG NETWORKS PRIVATE LIMITED, Madinaguda, Hyderabad (IN)

(72) Inventors: Koteswara Rao Gudimitla, Srikalahasti, Andhra Pradesh (IN); Sibgath Ali Khan Makandar, Khizra Enclave, Hyderabad (IN); Saidhiraj Amuru, Manikonda, Hyderabad (IN); Sakshama Ghoslya, Jaipur (IN); Kiran Kumar Kuchi, Madinaguda, Hyderabad (IN)

(21) Appl. No.: 18/853,203

(22) PCT Filed: Feb. 13, 2023
(86) PCT No.: PCT/IN2023/050143

§ 371 Date: Oct. 1, 2024

(30) Foreign Application Priority Data
Apr. 12, 2022 (IN) 202241021881
May 26, 2022 (IN) 202241030370

(51) Int. Cl. H04L 5/00; H04L 25/02

(52) U.S. Cl. CPC H04L 5/0051; H04L 5/0023; H04L 25/0224

(57) ABSTRACT

Embodiments of the present disclosure are related, in general to communication, but exclusively related to methods and systems methods for transmitting a waveform. The waveform is a pre-DFT RS and data multiplexed DFT-S-OFDM with excess bandwidth shaping and MIMO. Also, embodiments of the present disclosure relate to methods of detecting the received data. The method for transmitting a waveform, comprising generating, by one or more transmitters, at least one data sequence and at least one reference sequence (RS). Also, the method comprises time-multiplexing the at least one data sequence with the at least one RS, to generate a multiplexed sequence. Further, the method comprises generating a filtered-extended bandwidth DFT-s-OFDM symbol using the multiplexed sequence. The filtered-extended bandwidth DFT-s-OFDM symbol generated by the one or more transmitters is transmitted in an OFDM symbol.

### CROSS-REFERENCE TO RELATED APPLICATIONS

This application claims priority from the Indian Provisional Patent Application Numbers i) 202241021881, filed on Apr. 12, 2022; and ii) 202241030370 filed on May 26, 2022, the entirety of which are hereby incorporated by reference.

### TECHNICAL FIELD

Embodiments of the present disclosure are related, in general to communication, but exclusively relate to methods and apparatus for generating and transmitting Pre DFT RS and Data Multiplexed DFT-S-OFDM with excess bandwidth shaping for transmission using multiple antennas or multiple users simultaneously

### BACKGROUND

3GPP (3rd Generation Partnership Project) has developed 5G-NR standards to support use cases like eMBB, URLLC, MMTC. It has been agreed to use CP-OFDM waveform and DFT-s-OFDM waveform for uplink transmission in 5G-NR. Here, CP-OFDM is mainly used for higher data rates, while, because of its low PAPR and high-power efficiency, DFT-s-OFDM is used to serve the cell edge UEs. Current 5G standards uses slot structure, where transmitter data is transmitted in series of OFDM symbols. A typical slot structure comprises of one or more data symbols and one or more reference symbols.

6G Mobile Communication System requires a method of information transmission and that offers extremely low latency, very high data rate, and very high-power efficiency. DFT-S-OFDM waveform, which is power efficient and supports high data rates is well suitable for this purpose. However, to achieve extremely low latency, it is desirable to transmit the information (like transmitter data, RS, and control information) in a single shot i.e., using a single OFDM symbol. However, conventional DFT-S-OFDM requires at least one data symbol and at least one reference symbol (RS). The RS is required for the purpose of estimating the channel state information (CSI) and subsequent equalization of data symbol. This two-symbol structure not only doubles the latency (compared to single symbol case), but also has a higher RS overhead i.e., 50%. There is a need for a new type of waveform that allows one shot transmission with flexible RS overhead and high-power efficiency and allows transmission using multiple antennas or multiple users or multiple transmitters simultaneously.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for transmitting a waveform is disclosed. The method comprising generating, by one or more transmitters, at least one data sequence and at least one reference sequence (RS), said at least one RS includes one or more transmitter specific RS associated with each of the one or more transmitters. The method also comprises time-multiplexing, by the one or more transmitters, the at least one data sequence with the at least one RS, to generate a multiplexed sequence. Further the method comprises generating, by the one or more transmitters, a filtered-extended bandwidth DFT-s-OFDM symbol using the multiplexed sequence. The filtered-extended bandwidth DFT-s-OFDM symbol generated by the one or more transmitters are transmitted in an OFDM symbol/slot at the same time instant.

In one aspect of the present disclosure a method for transmitting a slot is disclosed. The method comprising a plurality of OFDM symbols, said plurality of OFDM symbols includes at least one of: at least one filtered-extended bandwidth DFT-s-OFDM symbol comprising of RS and data at least one filtered-extended bandwidth DFT-s-OFDM symbol comprising of full RS, and at least one filtered-extended bandwidth DFT-s-OFDM symbol comprising of full data. The plurality of OFDM symbols includes at least one of a filtered-extended bandwidth DFT-s-OFDM symbol comprising of RS and data is filtered using a first filter, filtered-extended bandwidth DFT-s-OFDM symbol comprising of RS is filtered using a second filter, filtered-extended bandwidth DFT-s-OFDM symbol is filtered using a third filter, said filter have one on one correspondence among each other.

In another aspect of the present disclosure a method for receiving a waveform is provided. The method comprising processing, by a receiver, the received waveform to obtain a time domain sequence and de-multiplexing the time domain sequence to obtain at least one of a reference sequence and a data sequence. The processing the received waveform comprising performing one of coherently adding an extended bandwidth and removal of an extended bandwidth from the received waveform, to obtain a processed sequence. Also, the method comprises obtaining one or more transmitter specific reference sequences (RSs) by performing de-multiplexing operation on the processed sequence and estimating a channel by using the one or more transmitter specific RS based on an estimation method to obtain a transmitter specific estimated channel. Further, the method comprises equalizing the processed sequence using the transmitter specific estimated channel to obtain a transmitter specific equalized sequence and performing an Inverse Discrete Fourier Transform (IDFT) on the transmitter specific equalized sequence to generate a time domain sequence.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1 shows a symbol with DMRS in the middle of OFDM symbol along with pre-fix and post-fix;

FIG. 2 shows a symbol with two RS blocks at the symbol boundaries and data in the middle of OFDM symbol;

FIG. 3 shows a Symbol with RS with pre-fix and post-fix at ¼th and ¾th positions of OFDM symbol;

FIG. 4 shows a Symbol with RS with pre-fix and post-fix starting at 0th and ½th positions of OFDM symbol;

FIG. 5 shows a Symbol with two RS blocks at the symbol boundaries, one in the middle for channel estimation;

FIG. 6 shows Symbol with two RS blocks at the symbol boundaries and data in the middle of OFDM symbol for phase tracking;

FIG. 7 shows a symbol with RS with pre-fix and post-fix at ¼th of symbol along with RS without CP for phase tracking;

FIG. 8A shows a symbol with two RS blocks at the symbol boundaries for phase tracking, one in the middle for channel estimation;

FIG. 8B shows a symbol with two RS blocks at the symbol boundaries, one in the middle for phase tracking;

FIG. 9A shows an illustration of RS-data multiplexed symbol structure for n transmitters;

FIG. 9B shows symbol structure where RS in multiple transmitters having only pre-fix;

FIG. 9C shows symbol structure where RS in multiple transmitters having only post-fix;

FIG. 9D shows an illustration of generating user specific RS with cover code;

FIG. 9E shows an illustration of transmitter specific RS index mapping, in an embodiment of the present disclosure;

FIG. 9F shows an illustration of transmitter specific RS index mapping, in another embodiment of the present disclosure;

FIG. 10A shows symbol structure for multiple transmitters with RS repetition and block wise orthogonal cover code;

FIG. 10B shows symbol structure for multiple transmitters with same RS sequence repeated and sample wise orthogonal cover code;

FIG. 10C shows symbol structure for multiple transmitters with different RS sequences repeated and sample wise orthogonal cover codes;

FIG. 10D shows plurality of RS sequences in multiplexed with data;

FIG. 10E shows plurality of transmitters having plurality of RS sequences;

FIG. 10F shows plurality of RS sequences, where both the sequences have either cyclic prefix/suffix or both cyclic prefix and suffix;

FIG. 10G shows symbol structure where data has both cyclic prefix and suffix;

FIG. 11A shows a block diagram of transmitter illustrating multiplexing of Data and RS in one OFDM symbol, with spectrum shaping and excess bandwidth;

FIG. 11B shows a block diagram of transmitter illustrating multiplexing of Data and RS in one OFDM symbol, with spectrum shaping in time-domain and without excess bandwidth;

FIG. 12A shows a block of a transmitter illustrating multiplexing of Data and RS multiplexed in one OFDM symbol, with spectrum shaping in frequency-domain and without excess bandwidth;

FIG. 12B shows a block diagram of a transmitter in a communication network, in accordance with an exemplary embodiment of the present disclosure;

FIG. 12C shows a block diagram of extended BW symbol generator, in accordance with an embodiment of the present disclosure;

FIG. 13 shows a block diagram of a receiver for receiving Data and RS multiplexed in one OFDM symbol, with spectrum shaping and excess bandwidth;

FIG. 14 an illustration of obtaining M samples from M+d samples;

FIG. 15 shows a receiver receiving for Data and RS multiplexed in one OFDM symbol with spectrum extension shaping and receiver spectrum shaping;

FIG. 16A shows a receiver for receiving two RS blocks, with estimation on each RS block;

FIG. 16B shows a receiver for receiving two RS blocks, with phase estimation on secondary RS block;

FIG. 17A show block diagram of a receiver for detecting the received data, in accordance with an embodiment of the present disclosure;

FIG. 17B show block diagram of a receiver for detecting the received data, in accordance with another embodiment of the present disclosure;

FIG. 17C shows a block diagram of a receiver for estimation and data detection;

FIG. 17D shows a block diagram of a receiver for estimation and phase tracking;

FIG. 17E shows a block diagram of a receiver for estimation and channel tracking;

FIG. 17F shows a block diagram of a receiver for estimation and equalization;

FIGS. 18 and 19 shows the effective time channel on the OFDM symbol post CP removal and post IDFT at the receiver, respectively;

FIG. 20 shows an illustration of BLER performance of Pre-DFT RS and data multiplexing without spectral extension and shaping for allocation of 1200 subcarriers in one sample delay channel;

FIG. 21 shows a plot illustrating BLER performance comparison in delay 1/1200 channel, with and without spectrum extension and shaping;

FIG. 22 shows a plot illustrating BLER performance comparison in delay 5/1200 channel, with different spectrum extension values and same RS, CP lengths;

FIG. 23 shows a plot illustrating BLER performance comparison in delay 5/1200 channel, with same spectrum extension values and different RS, CP lengths;

FIG. 24 shows an effective channel on the OFDM symbol post CP removal at the receiver for TDL-C 100 nsec;

FIG. 25 shows a plot illustrating an Effective channel on the OFDM symbol post IDFT at the receiver for TDL-C 100 nsec;

FIG. 26 shows a plot illustrating an Effective channel on the OFDM symbol post CP removal at the receiver for TDL-C 300 nsec;

FIG. 27 shows a plot illustrating an Effective channel on the OFDM symbol post IDFT at the receiver for TDL-C 300 nsec;

FIG. 28 shows a plot illustrating an BLER performance in TDL-C 100 nsec with 28% RS+CP OH for 1×1 and 2×1 systems and 256 QAM, R=0.89 (M=1200), 10% extension;

FIG. 29 shows a plot illustrating an BLER performance in TDL-C 300 nsec with 32% RS+CP OH for 1×1 and 2×1 systems and 256 QAM, R=0.89 (M=1200), 10% extension;

FIG. 30 shows a plot illustrating BLER performance in TDL-C 100 nsec with 20% RS+CP OH for 2×1 system and 256 QAM and R=0.89 with different FFT sizes (M=600), 10% extension;

FIG. 31 shows a plot illustrating an BLER performance in TDL-E 100 nsec with 28% RS+CP OH for 1×1 and 2×1 system and 256 QAM, R=0.89 with different FFT sizes (M=1200), 10% extension;

FIG. 32 shows a plot illustrating BLER performance in TDL-E 100 nsec with 28% RS+CP OH for 2×1 stem and 256 QAM, R=0.89 comparing SQRC and 2-tap filters (M=1200), 10% extension;

FIG. 33 shows a plot illustrating BLER performance in TDL-C 100 nsec with 21% RS+CP OH for 1×1 system and pi/2-BPSK modulation comparing true channel and estimated channel (M=1200), 10% extension;

FIG. 34 shows a block diagram of a Transmitter for Data and RS multiplexed in one OFDM symbol and multi transmitter, with spectrum shaping and excess bandwidth;

FIG. 35 shows a block diagram of a transmitter to transmit Pre-DFT RS data multiplexing with spectrum extension and shaping for multi-transmitter with OCC in frequency domain;

FIG. 36 shows a block diagram of a multi-transmitter system for transmission of data and RS multiplexed in one OFDM symbol with spectrum shaping and excess bandwidth, in accordance with an embodiment of the present disclosure;

FIG. 37 shows a block diagram of a multi-transmitter system for transmission of RS in one OFDM symbol with spectrum shaping and excess bandwidth, in accordance with an embodiment of the present disclosure;

FIG. 38 shows a block diagram of a multi-transmitter system for transmission of data in one OFDM symbol with spectrum shaping and excess bandwidth, in accordance with an embodiment of the present disclosure;

FIG. 39 shows a block diagram of a communication system with a plurality of users having multiple transmitters, in accordance with an embodiment of the present disclosure;

FIG. 40 shows a block diagram of a communication system with a user having multiple transmitters, in accordance with an embodiment of the present disclosure;

FIG. 41 shows a block diagram of a communication system with a plurality of users, each user having at least one transmitter, in accordance with another embodiment of the present disclosure;

FIG. 42 shows a block diagram of a base station having multiple transmitters, in accordance with an embodiment of the present disclosure;

FIG. 43 shows a block diagram of a receiver for receiving signal from a MIMO system, in accordance with an embodiment of the present disclosure;

FIG. 44 shows a block diagram of a receiver for receiving signal with phase estimation and correction, from a MIMO system, in accordance with an embodiment of the present disclosure;

FIG. 45 shows a plot illustrating frequency response of 2-tap filter obtained from over sampling of LGMSK pulse;

FIG. 46 shows a plot illustrating magnitude of square root of Frequency response of 2-tap filter obtained from over sampling of LGMSK pulse;

FIG. 47 shows a plot illustrating frequency response of raised cosine pulse;

FIG. 48 shows a plot illustrating magnitude of square root of frequency response of raised cosine pulse;

FIG. 49 shows a plot illustrating frequency response of square root raised cosine pulse;

FIG. 50 shows a plot illustrating magnitude of square root of frequency response of square root raised cosine pulse;

FIGS. 51A and 51B shows an illustration of a first filter and a second filter of a transmitter respectively, in accordance with an embodiment of the present disclosure;

FIGS. 51C, 51D and 51E shows illustration of various OFDM symbols in a slot, in accordance with an embodiment of the present disclosure;

FIG. 52 shows a flowchart illustrating a method for transmitting a waveform in a communication network, in accordance with some embodiments of the present disclosure;

FIG. 53 shows a flowchart illustrating a method for receiving a waveform in a communication network, in accordance with some embodiments of the present disclosure; and

FIG. 54 shows a flowchart illustrating a method for receiving a waveform in a communication network, in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Embodiments of the present disclosure relate to generating pre DFT RS and data multiplexed DFT-S-OFDM with excess bandwidth shaping and detecting the received data. The RS and transmitter data are transmitted in different OFDM symbols, such that channel estimation to equalize the data is estimated clearly at the receiver. However, this has higher latency and may be not enough for further communications standards like 6G, which requires low latency. To support low latency RS and data is multiplexed with in OFDM symbol. With CP-OFDM, it is possible without much complexity, but has lower power efficiency. The present disclosure provides methods to transmit in one symbol with additional parameters. These method helps in transmitting RS and transmitter data in one OFDM symbol with DFT-s-OFDM, which eventually offers low PAPR. Methods to transmit the multiple transmitters with each transmitter having multiplexed RS and data are also presented in the disclosure to improve spectral efficiency.

Embodiments of the present disclosure relates to methods of transmitting and receiving DFT-S-OFDM with RS and Data time multiplexed, spectrally shaped using excess bandwidth, and simplifies the transmission using multiple antennas or multiple users in a power efficient manner. In an embodiment, a method uses DFT-S-OFDM with RS and Data time multiplexed before the application of DFT pre-coding. The DFT precoded data is then mapped to the allocated subcarriers, which is followed by IFFT and phase compensation for each symbol by multiplying with a symbol specific exponential value. A symbol level Cyclic Prefix (CP) that the is last “v” number of IFFT output may be appended at the beginning of the IFFT output followed by windowing or windowing with over-lap and add (WOLA) or transmit filtering (low-pass or bandpass digital filter). This method is referred to as pre-DFT RS and Data multiplexing/DFT-s-OFDM symbol comprising of data and RS.

At the receiver, the RS is used for channel estimation followed by equalization of the received data. However, in channels where there is a delay (or timing error) at the receiver, the impulse response (IR) or the inter-symbol-interference (ISI) experienced by the system becomes a sync-like pulse whose length is equal to the DFT size. The power of the channel taps in the IR decays very slowly and therefore a RS of finite size whose length is less than the DFT size will not be able to estimate the complete channel. Simulations show that, when RS and Data are multiplexed in this manner, higher order modulation (HOM) suffers from an irreducible error floor.

In an embodiment, the bandwidth of the “pre-DFT RS and Data multiplexing signal” is expanded, using additional subcarriers, followed by shaping the spectrum by using a pulse shaping filter such as square-root-raised-cosine pulse that follows Nyquist criterion for zero ISI (when the receiver has no timing error). This pulse concentrates most of the signal energy around the main lobe and the side lobes decay to a low enough energy not to cause significant ISI. This method is referred as “Pre DFT RS and Data Multiplexed DFT-S-OFDM with excess bandwidth shaping or filtered-extended bandwidth DFT-s-OFDM symbol comprising of data and RS”. The design parameters: RS density (length of RS), the excess BW and the DFT size may be selected carefully to eliminate the error floor caused by the ISI channel.

Advantages of the “Pre DFT RS and Data Multiplexed DFT-S-OFDM with excess bandwidth shaping” signal are that the spectrum shaping of excess BW reduces the PAPR and increases the overall transmission power. Another advantage is that multiple RS blocks may be multiplexed to track the channel. In one embodiment, a “long/main RS block” is used to the estimate the overall impulse response and “short/additional RS blocks” (including single pilot) may be distributed over the span of the symbol to track the phase changes. Alternatively, multiple RS blocks of equal length is used to estimate the channel locally and equalize the adjacent data blocks. The “Pre DFT RS and Data Multiplexed DFT-S-OFDM with excess bandwidth shaping” may also be referred as “filtered-extended bandwidth DFT-s-OFDM symbol comprising of data and RS”.

Spectrum is very scarce resource, hence should be judiciously used. Efficiency of spectrum usage is defined as spectral efficiency, which is measured in bits/sec/Hz. More the spectral efficiency, better the usage of spectrum. One possible way of achieving better spectral efficiency is to use higher modulation orders like 64QAM, 256 QAM, 1024QAM etc. The other possible way is to transmit multiple transmitter data on the same time-frequency resource i.e., spatial multiplexing using multiple transmit antennas or multiple users. When transmitters are spatial multiplexed, the receiver should observe orthogonality across the transmitter RS signals to estimate the channel corresponding to each transmitter independently.

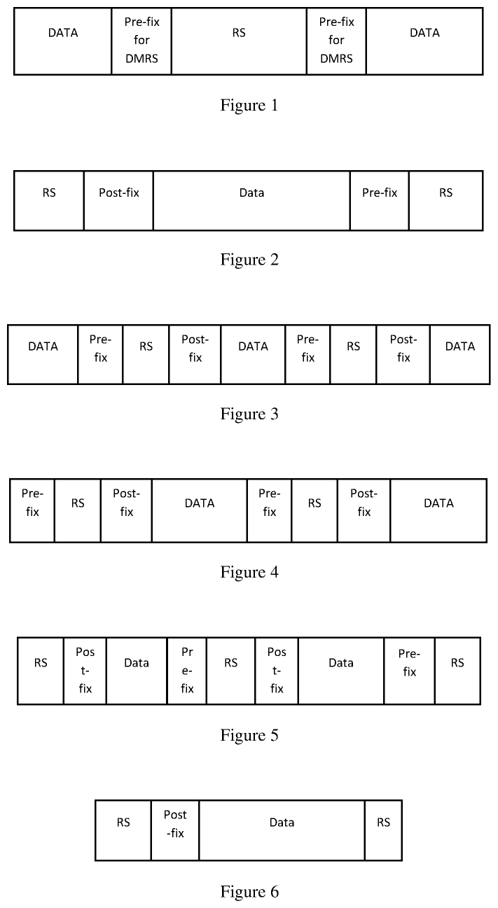

One embodiment of the present disclosure is a transmitter which transmits a filtered-extended bandwidth DFT-s-OFDM symbol, comprising of at least one of: at least one a data and at least one RS are transmitted in the same OFDM symbol. The at least one data is referred as the data. The at least one RS is referred as the RS. The data and the RS are multiplexed before DFT-precoding in the time domain. Data and RS are sequence of samples. The position of RS may be in the center or starting or ending of the OFDM symbol. This kind of RS may be referred as long/main/localized RS. To support better channel estimation either cyclic pre-fix (RS-CP) or cyclic post-fix (RS-CS) or both pre-fix and post-fix will be added to the RS in the time domain. The sequence to be used as RS is one of pi/2-binary phase shift keying (BPSK), a Quadrature Phase Shift Keying (QPSK), M-ary Phase Shift Keying (PSK), and Zadoff-chu (ZC) sequence. The sequences may be obtained using one of m-sequences, Pseudo-Noise (PN) sequences, Kasami, Walsh, and Hadamard codes. The Frequency spectrum of RS should be as flat as possible to ensure reliance channel estimation. RS and RS-CP or RS-CS may occupy a portion of resources allocated to the transmitter, which may depend on properties of channel conditions, Excess bandwidth, transmitter allocation size, modulation order, coding rate, and other parameters like impulse response of spectrum shaping filter. FIG. 1 shows a symbol with RS in the middle of OFDM symbol along with pre-fix and post-fix.

In another embodiment, a multiple RS blocks may be used while multiplexing RS with data. Each of the multiple RS blocks is a transmitter specific RS. One possible way is to keep more than one block of RS samples with each block having same number of samples. The RS block occupies any positions in the symbol, like shown the FIGS. 2 to 5, which are for 2 blocks and 3 blocks. However, it may be extended to any number of blocks and any other configuration. RS in each block may be the same sequence or different. This kind of each RS block may be referred as long/main/localized/primary RS block, and all the blocks will either have both RS pre-fix and RS-post-fix or RS-post-fix or RS-pre-fix. Each block will be used for channel estimation and the transmitter data followed by the block will be equalized with the channel that is estimated. This kind of design helps in tracking the high Doppler channel or phase error caused by the crystal oscillator, which may vary within an OFDM symbol. When RS samples are at the symbol boundaries, they may not need either RS-pre-fix or RS-post-fix. The different main block RS may be adjacent to each other or separated.

FIG. 2 shows a symbol with two RS blocks at the symbol boundaries and data in the middle of OFDM symbol. FIG. 3 shows a Symbol with RS with pre-fix and post-fix at ¼^{th} and ¾^{th} positions of OFDM symbol. FIG. 4 shows a Symbol with RS with pre-fix and post-fix starting at 0^{th} and ½^{th} positions of OFDM symbol. FIG. 5 shows a Symbol with two RS blocks at the symbol boundaries, one in the middle for channel estimation.

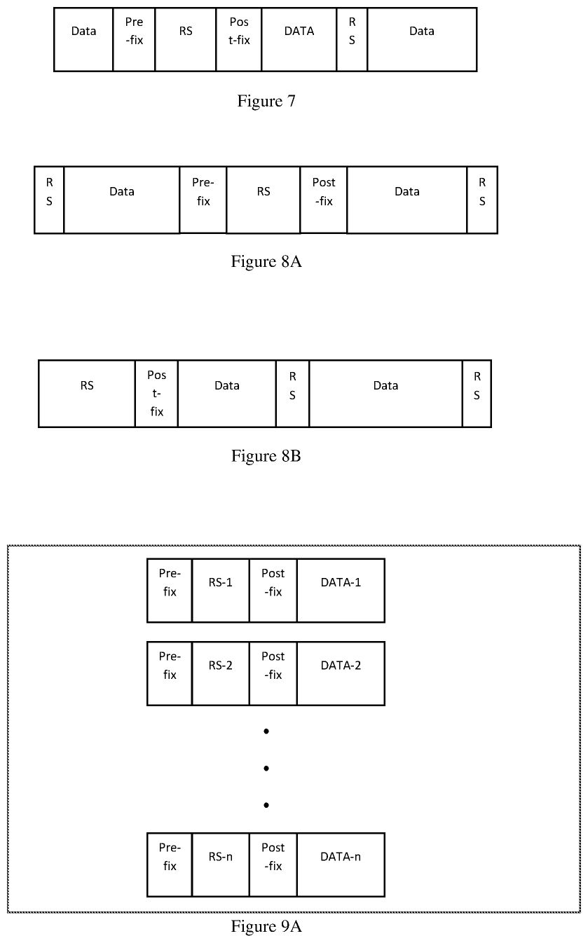

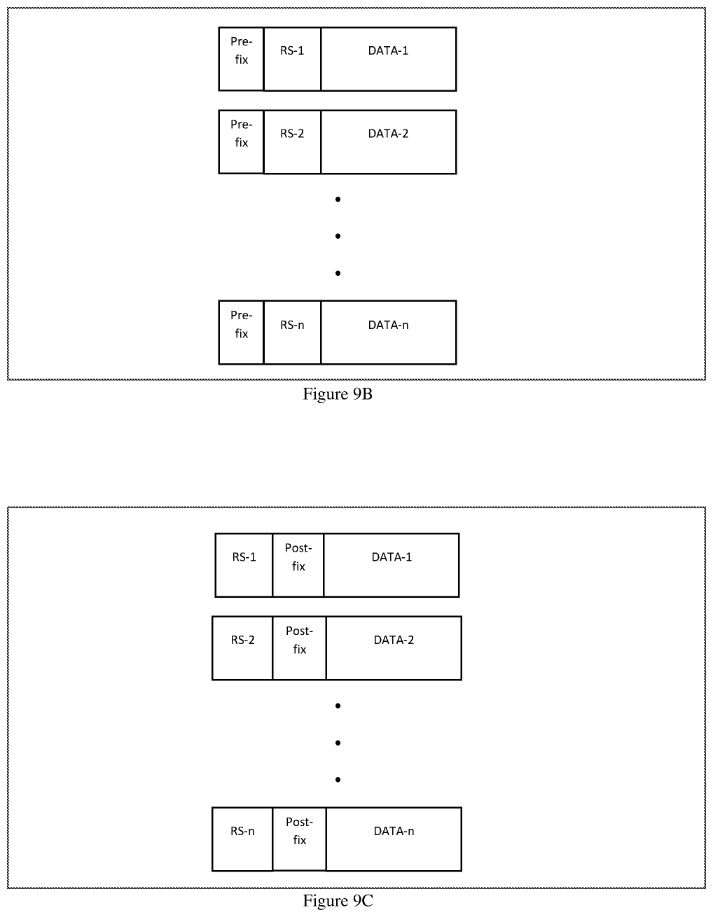

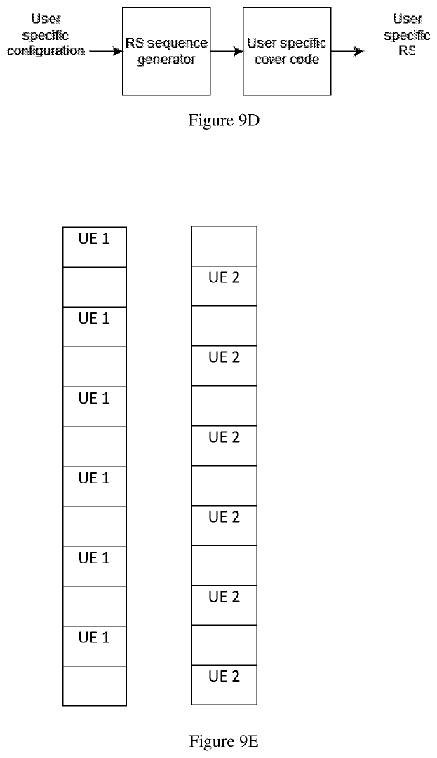

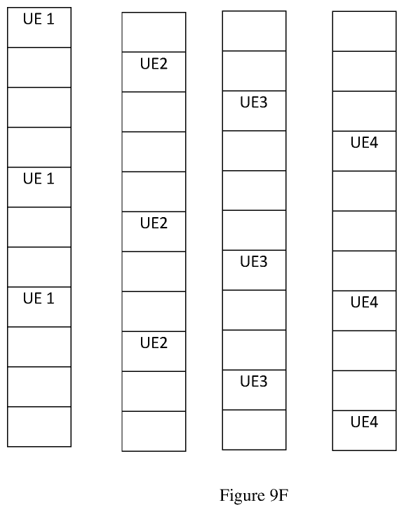

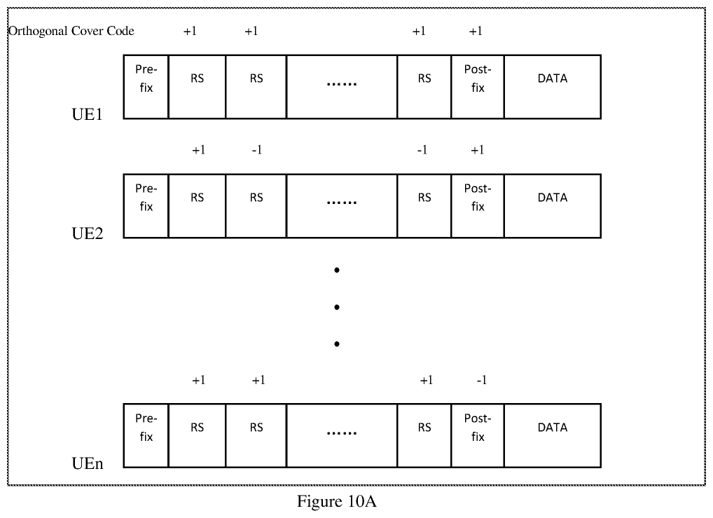

In another embodiment, the size of each block is different. Here, size of one block may be larger, while the sizes of all the other blocks is small or even simply once sample. The main block with larger RS sizes may have RS-pre-fix or RS-post-fix or both RS-pre-fix and RS-post-fix. Main RS block will be used for channel estimation, while the smaller blocks may be used for phase tracking with in the OFDM symbol. The smaller RS blocks may be referred as distributed/secondary/phase tracking RS block also. The smaller block RS samples may be at least one sample obtained from the main RS block or obtained from separately generated sequences. FIGS. 6 and 7 shows the symbol structure with two RS blocks, while one has both RS-Pre-fix and RS-post-fix, while the other block has no RS-CP. Similar symbol structure 3 RS blocks are show in FIGS. 8 and 9. Similar structure may be extended for any number of blocks. The block is a transmitter specific RS, in an embodiment. The smaller RS block may have only one sample obtained from one of the sample of the one of the main RS block or may be a separately generated sequence. The RS multiplexed with data in filtered-extended bandwidth DFT-s-OFDM symbol comprising of data and RS may have one of at least one main RS block and one secondary RS block.

FIG. 6 shows Symbol with two RS blocks at the symbol boundaries and data in the middle of OFDM symbol for phase tracking. FIG. 7 shows a symbol with RS with pre-fix and post-fix at ¼^{th} of symbol along with RS without CP for phase tracking. FIG. 8A shows a symbol with two RS blocks at the symbol boundaries for phase tracking, one in the middle for channel estimation. FIG. 8B shows a symbol with two RS blocks at the symbol boundaries, one in the middle for phase tracking.

One embodiment of the present disclosure is RS generation for different transmitters. In one case, the RS sequence for a given transmitter may be obtained by cyclically shifting the base reference sequence. The base sequence has to obtain transmitter specific RS, which may be one of pi/2-BPSK, QPSK, PSK, and ZC sequences. The base sequence generation may depend on the cell ID, transmitter specific ID, symbol index, scrambling ID, antenna port, and slot number. The cyclic shifts to be used for each transmitter may be one of factor of length of RS sequence, and ceil, floor, or round of the length of the RS sequence, and the number of transmitters to be multiplexed. The symbol structure for the transmitter is shown FIG. 9A. The transmitter specific RS to be used for channel estimation may have either RS-pre-fix or RS-post-fix or both RS-pre-fix and RS-post-fix. FIG. 9B shows symbol structure where RS in multiple transmitters having only RS-pre-fix. FIG. 9C shows symbol structure where RS in multiple transmitters having only RS-post-fix.

Illustrating the method mentioned in the above procedure, let the number of transmitters to be used be 4. The base sequence to be used in generating the RS for multiple transmitters be r(n) of length Nᵣ. The cyclic shifts to be used to generate transmitter specific RS be

$$\{ \frac{{N}_{r}}{2} , \frac{{N}_{r}}{4} , \frac{3 {N}_{r}}{4} , 0 \} ,$$

hence, the KS sequences for transmitter 1, 2, 3, and 4 may be given by:

$$RS for user 1 \text{:} {r}_{1} ( n ) = r ( n - \frac{{N}_{r}}{2} ) \to {R}_{1} = circ ( {r}_{1} ( n ) )$$

$$RS for user 2 \text{:} {r}_{2} ( n ) = r ( n - \frac{{N}_{r}}{4} ) \to {R}_{2} = circ ( {r}_{2} ( n ) )$$

$$RS for user 3 \text{:} {r}_{3} ( n ) = r ( n - \frac{3 {N}_{r}}{4} ) \to {R}_{3} = circ ( {r}_{3} ( n ) )$$

$$RS for user 4 \text{:} {r}_{4} ( n ) = r ( n ) \to {R}_{4} = circ ( {r}_{4} ( n ) )$$

$${R}_{i} \times {R}_{i} = I$$

$${R}_{i} \times {R}_{j} = {P}_{ij} - Permutation matrix$$

In another embodiment, RS sequence for different transmitters is generated using a base RS repetitions and transmitter specific cover code. The RS for each transmitter is repeated at least the number of transmitters available. A transmitter specific block wise cover code is applied on the repeated sequence. FIG. 9D shows RS generation with cover code. For a base sequence of length Nᵣ and for Nₜ number of transmitters to be multiplexed, the length of each RS sequence of each transmitter is at least Nᵣ×Nₜ. The transmitter specific block wise cover codes are orthogonal to each other. The RS for each transmitter may be the same sequence obtained from a base sequence or different sequences, and sequences may be pi/2-BPSK, QPSK, PSK, or ZC sequences. The base sequence generation or the transmitter specific sequence may depend on the cell ID, transmitter specific ID, symbol index, scrambling ID, antenna port, and slot number. The block wise spreading codes may be a PN sequence, Hadamard codes or Walsh codes. The block wise spreading code may be obtained from one of m-sequences, PN sequences, Kasami. The transmitter specific RS to be used for channel estimation may have either RS-pre-fix or RS-post-fix or both RS-pre-fix and RS-post-fix.

Let the base sequence of each RS block be r(n) of size Nᵣ, where Nᵣ is the length of RS block to be used to generate RS for each transmitter. The number of transmitters that are multiplexed be Nₜ. Hence, the size of RS for each transmitter is Nᵣ×Nₜ. Considering a two-transmitter case, the length of the RS is 2×Nᵣ. The RS for first transmitter is given by

$${r}_{1} ( n ) = r ( n mod ( {N}_{r} \times 2 ) )$$

Similarly, the RS for the second user is given by

$${r}_{2} ( n ) = r ( n mod ( {N}_{r} \times 2 ) ) {e}^{i π ⌊ \frac{n}{{N}_{r}} ⌋}$$

Here, n={0, 1, 2, 3, . . . , Nᵣ×2}

Here, └ ┘ is a flooring operation, where for a real number x, └x┘ gives the greatest integer, which is less than or equal to x. With this kind of RS structure defined for the two transmitters, the Fourier transform of RS of the first transmitter will occupy the even indices, while the Fourier transform of the RS of the second transmitter will occupy the odd indices. The same is depicted in the FIG. 9E.

In another case, where the orthogonal sequence is obtained using one of the sequences defined above, the block wise cover code for each user is given by b₁(n), and b₂(n) of length Nₜ. With base RS block sequence being r(n), the RS sequence for each is given by

$${r}_{1} ( n ) = {b}_{1} ( ⌊ \frac{n}{{N}_{r}} ⌋ ) r ( n mod ( {N}_{r} \times 2 ) )$$

$${r}_{2} ( n ) = {b}_{2} ( ⌊ \frac{n}{{N}_{r}} ⌋ ) r ( n mod ( {N}_{r} \times 2 ) )$$

Here, └ ┘ is a flooring operation, where for a real number x, └x┘ gives the greatest integer, which is less than or equal to x.

In another embodiment, RS sequence for different transmitters is generated using a base RS block repetitions and transmitter specific cover code. The RS for each transmitter is repeated as the number of transmitters available. A transmitter specific sample cover code is applied on the repeated sequence. FIG. 9D shows an illustration of generating user specific RS with cover code. For a base sequence of length Nᵣ and for Nₜ number of transmitters to be multiplexed, the length of each RS sequence of each transmitter is at least Nᵣ×Nₜ. The transmitter specific sample wise cover codes are orthogonal to each other. The RS for each transmitter may be the same sequence obtained from a base sequence or different sequences, and sequences may be pi/2-BPSK, QPSK, or ZC sequence. The base sequence generation or the transmitter specific sequence may depend on the cell ID, transmitter specific ID, symbol index, scrambling ID, antenna port, and slot number, and the number of transmitters. The sample wise transmitter specific cover code may be an exponential cover code, where the phase in the exponential part is a function of the length of the RS sequence of each transmitter, which is inherently a function of number of transmitters that are multiplexed. The phase of the sample wise cover code may depend on the port number, user index, symbol index, slot index, and the number of the multiplexed transmitters.

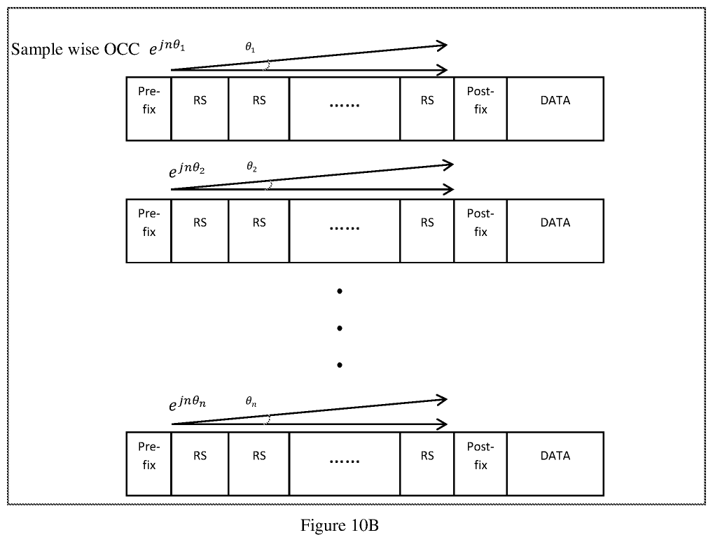

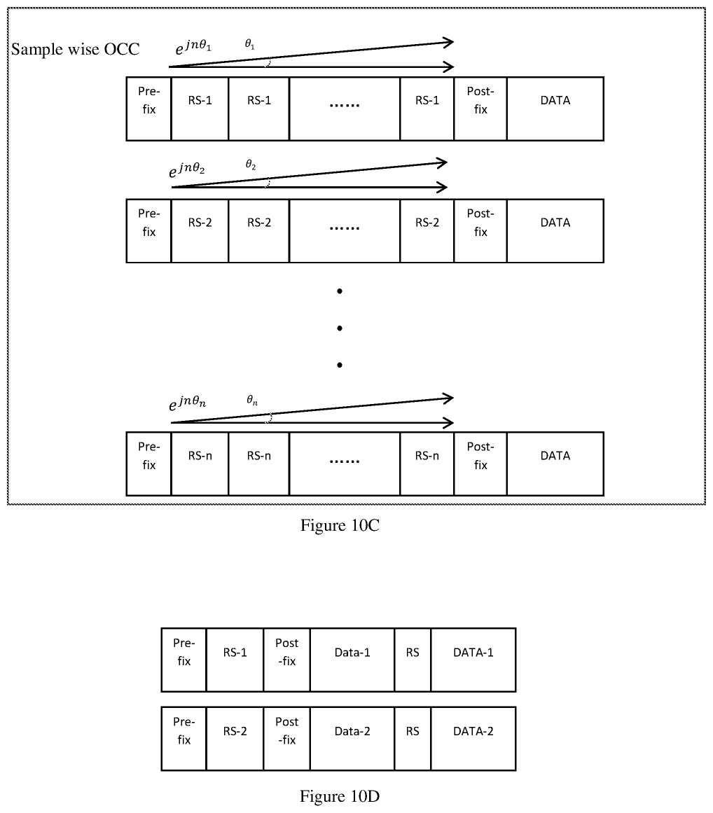

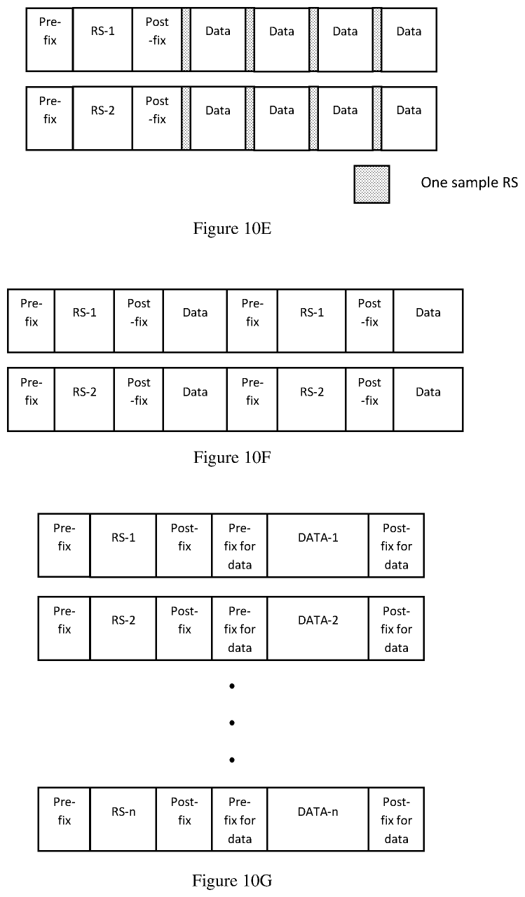

FIG. 10A shows symbol structure for multiple transmitters with RS repetition and block wise orthogonal cover code. FIG. 10B shows symbol structure for multiple transmitters with same RS sequence repeated and sample wise orthogonal cover code. FIG. 10C shows symbol structure for multiple transmitters with different RS sequences for each transmitter repeated and sample wise orthogonal cover codes. The transmitter specific RS to be used for channel estimation may have either RS-pre-fix or RS-post-fix or both RS-pre-fix and RS-post-fix.

Illustrating the above procedure consider the number of transmitters that needs to be multiplexed be 4. Let the base RS sequence used to generate transmitter specific RS sequence be r(n), which is of length Nᵣ. Hence, the length of RS sequence for each transmitter Nᵣ×4. The exponential cover code must be user specific, and the phases used to generate the cover code for the 4 users be

$$\{ 0 , \frac{2 π}{4 \times {N}_{r}} , \frac{4 π}{4 \times {N}_{r}} , \frac{6 π}{4 \times {N}_{r}} \} .$$

With these defined phases and the base sequence r(n), the RS sequence for each transmitter is represented as:

$$RS for transmitter 1 \text{:} {r}_{1} ( n ) = r ( n mod {N}_{r} \times 4 )$$

$$RS for transmitter 2 \text{:} {r}_{2} ( n ) = r ( n mod {N}_{r} \times 4 ) {e}^{\frac{i 2 π n}{4 \times {N}_{r}}}$$

$$RS for transmitter 3 \text{:} {r}_{3} ( n ) = r ( n mod {N}_{r} \times 4 ) {e}^{\frac{i 4 π n}{4 \times {N}_{r}}}$$

$$RS for transmitter 4 \text{:} {r}_{4} ( n ) = r ( n mod {N}_{r} \times 4 ) {e}^{\frac{i 6 π n}{4 \times {N}_{r}}}$$

Here, n={0, 1, 2, 3, . . . , Nᵣ×4}

With this kind of RS structure defined for the four transmitters, the Fourier transform of RS of the first transmitter will occupy one index for every four tones staring from 0, while the Fourier transform of the RS of the second transmitter will occupy one index for every four tones starting from 1. Transmitter three occupy one index for every four tones starting from 2, while fourth transmitter will occupy one index for every four tones starting from 3. The same is depicted in the FIG. 9F

The similar method can be extended to any number of transmitters by providing repetition of base RS to at least the size of the transmitters that are multiplexed and appropriate phase angles.

In another embodiment, RS sequence for different transmitters is generated using a base PN sequence and cyclic shifted versions of the base sequence. For a base sequence of r(n) of length Nᵣ, the RS sequence for transmitter 1 may be obtained by r(n−n₁), and for transmitter 2 may be obtained by r(n−n₂), such that the RS sequences of transmitter 1 and transmitter 2 may be orthogonal. In another embodiment, the transmitter specific RS may be one sample and it is spreaded to the length of RS using a spreading sequence obtained from one of ZC, PN sequences, M-sequences, or Kasami gold sequences. The spreading sequences are orthogonal to each other. For example, consider the RS sample corresponding transmitter 1 and transmitter 2 may be r₁ and r₂. The sequence used for spreading sequence may be s₁(n) and s₂(n). Here, s₁(n) and s₂(n) are orthogonal sequences. The final RS for each transmitter is obtained by multiplying the transmitter specific RS sample with transmitter specific orthogonal sequence i.e., for first transmitter, the final RS sequence will be r₁s₁(n), while for second transmitter final RS sequence will be r₂s₂(n). This can be extended to any number of transmitters.

In an embodiment, the transmitter specific RS sequence may be obtained from the same base sequence or different base sequence. In the process of obtaining transmitter specific RS sequence, the base sequence may be repeated at least as the number of available transmitters. The base sequence may be applied with a block wise cover code, where each repeated RS sequence is multiplied with one sample of the cover code. The block wise cover codes may be orthogonal to each other. In another embodiment, for obtaining transmitter specific RS sequence, a sample wise cover code is applied on the base RS sequence, where element by element wise product of RS with cover code is performed. The sample wise cover codes may be orthogonal to each other. The transmitter specific RS to be used for channel estimation may have either RS-pre-fix or RS-post-fix or both RS-pre-fix and RS-post-fix.

In another embodiment, in generation of transmitter specific RS sequence, the base RS sequence may be repeated as a function of the number of transmitters. The repeated RS sequence may be applied with a transmitter specific first phase of cover code and with another transmitter specific second phase of cover codes. The first phase and second phase cover codes may be same or different. The transmitter specific cover codes may be orthogonal to each other. In another embodiment, transmitter specific RS may involve plurality of cover codes. In another embodiment, the RS may not be repeated, and each transmitter specific RS sequence may be applied with plurality of RS sequences.

In another embodiment, the transmitter specific RS sequences are obtained in a combination of cyclic shifts and repetitions from the same base RS sequence or different base RS sequences. For at least one transmitter, RS sequence may be obtained by at least one of cyclic shift of base RS sequence and time domain repetition following transmitter specific cover code. For illustration, consider a case of 4 transmitters. The transmitters may be classified into two sets, where each set of users may be assigned with one RS sequence. The assigned RS sequence may be obtained from the same base RS sequence or different RS sequences. The assigned RS sequences per set may be repeated as the number of transmitters in the set. Here, since the number of transmitters per set is two, the RS sequence assigned to each set are repeated twice. At least once cover code is applied on the repeated time domain sequences to obtain time domain, or frequency domain, or code domain orthogonality across the transmitters in the set. To obtain orthogonality across the sets, the RS sequence per transmitter may be cyclically shifted in time domain to obtain frequency domain, or code domain orthogonality.

In an embodiment, the code cover may be a PN sequence. The PN sequence may be generated using a PN sequence generator. In an embodiment, each PN sequence may be configured to be orthogonal to each other by changing initial conditions of the PN sequence generator. In an embodiment, each of the PN sequence may be denoted as Orthogonal Code Cover (OCC). PN sequence may be used for block wise code cover or sample wise code cover.

Let the number of transmitters to be multiplexed be Nₜ. The base RS sequence corresponding to a transmitter ‘i’ be rᵢ(n), which is of length Nₜ×Nᵣₛ. The cover code corresponding of each transmitter obtained using PN sequence be wᵢ(n), n={0, 1, 2, 3, . . . Nₜ}. The final RS sequence for each transmitter is given by

$${r}_{i}^{f} ( n ) = {r}_{i} ( n ) {w}_{i} ( ⌊ \frac{n}{{N}_{t}} ⌋ ) , n = \{ 0 , 1 , 2 , 3 , …… {N}_{t} \times {N}_{rs} \} .$$

Here,

$${\sum }_{n = 0}^{{N}_{t}} {w}_{i} ( n ) {w}_{j} ( n ) = \{ \begin{matrix}{N}_{t} , & if i = j \\ 0 , & if i \neq j\end{matrix}$$

In an embodiment, a transmitter specific RS may have a plurality of transmitter specific code cover. The transmitter specific cover code may be a sample based or block wise code cover.

In an embodiment, with multiple RS, the RS sequence for each RS of a transmitter may be BPSK modulated sequence or any arbitrary sequence. The BPSK sequence may be multiplied with a spreading sequence to increase bandwidth capacity. The spreading sequence generation may depend on transmitter specific and presence of plurality of RS. In another embodiment, the RS sequences may be orthogonal sequences used for different transmitters by using an orthogonal code cover. In an embodiment, the transmitter specific code cover of successive reference sequence is orthogonal to each other. The sequence is transmitted using corresponding one or more antennas. In an embodiment, the one or more transmitters are one of a plurality of antennas of a user, and one or more users, said each of the one or more users comprises one or more antennas.

In an embodiment, with multiple RS, the RS sequence for each RS of a transmitter may be BPSK modulated sequence, which may be multiplied with a spreading sequence to increase bandwidth capacity. The spreading sequence generation may depend on transmitter specific and presence of plurality of RS. In another embodiment, the RS sequences may be orthogonal sequences used for different transmitters by using an orthogonal code cover. In an embodiment, the transmitter specific code cover of successive reference sequence is orthogonal to each other. The sequence is transmitted using corresponding one or more antennas.

In an embodiment, the smaller size RS sequence multiplexed with data may be covered with orthogonal cover codes. The orthogonal cover code on each smaller RS of a transmitter may be same or different, and is a function of the transmitter parameters. In another embodiment, the cover code on each smaller RS sequence may be same or different across all the transmitters. The orthogonal cover code on the smaller RS may be function of symbol index, cell ID, RNTI, slot number, scrambling ID. The terms ID, index, number may be used interchangeably. FIG. 10D shows plurality of RS sequences in multiplexed with data. One of the plurality of RS sequences, which is the main RS may have the longest lengths, which may have prefix or suffix or both prefix and suffix. The RS sequences which has lengths lesser than the main RS may be used for Doppler tracking or phase tracking. FIG. 10D shows symbol structure for plurality of transmitter having plurality of RS sequences where one of the RS sequence is used for channel estimation and the other will be used for phase or Doppler tracking or tracking of phase changes caused by the Oscillator

FIG. 10E shows plurality of transmitters having plurality of RS sequences, where the size of the RS sequences which are multiplexed with data may be of minimum size of one sample. In an embodiment, the RS-data multiplexed symbol structure for 2 transmitters with plurality of RS, which is used for phase tracking.

FIG. 10F shows plurality of RS sequences, where both the sequences have either RS-cyclic prefix/suffix or both RS-cyclic prefix and RS-suffix. In this embodiment, the length of all the RS sequences may be equal such that, all the RS sequences may be used for channel estimation or may be for phase or Doppler/Phase tracking. The location and the density of the smaller RS may depend on the frequency of phase tracking, or Doppler, and Signal to noise ration and interference. The smaller RS may be one of pi/2 BPSK sequences, QPSK, ZC, QPSK, or pi/2BPSK sequences obtained from one of PN sequences, Kasami, gold, and m sequences, or from a set of pre-defined sequences.

In an embodiment, the transmitters have multiple RS for channel estimation, then orthogonal code cover on each RS of each transmitter may be same or different, for plurality RS for each transmitter. Consider a case of Nₜ users having two RS for channel estimation. The RS for each ‘i^{th}’ user is given by rᵢ¹(n), and rᵢ²(n) obtained from a base sequence r(n) using one of the methods mentioned above. The cover code on ‘i^{th}’ RS of ‘j^{th}’ user is given by w (n), which may be a sample wise or block wise cover code. Here, for ‘i^{th}’ user,

$${\sum }_{n = 0}^{{N}_{t}} {w}_{i}^{j} ( n ) {w}_{i}^{k} ( n ) = \{ \begin{matrix}{N}_{t} , & if j = k \\ 0 , & if j \neq k\end{matrix}$$

for block wise cover code, where Nₜ is the number of transmitters that are multiplexed. And for ‘i^{th}’ user

$${\sum }_{n = 0}^{{N}_{r}} {w}_{i}^{j} ( n ) {w}_{i}^{k} ( n ) = \{ \begin{matrix}{N}_{r} , & if j = k \\ 0 , & if j \neq k\end{matrix} ,$$

where Nᵣ is the length of each RS of each user.

When user having more than one RS for channel estimation, the size of each RS may be same or different. The RS of each transmitter may be used for channel estimation or for phase tracking.

The cover code wᵢ^{j}(n) of i^{th} user and j^{th} RS sequence of a user may be obtained from PN sequences, m-sequences, Hadamard, Walsh codes, or predefined binary sequences, or ZC sequences. The RS sequence rᵢ^{j}(n) of user ‘j’ may have same length irrespective of index ‘i’, from which at least one sequence may be used for channel estimation while at least one other sequence may be used for phase tracking or Doppler estimation and correction. If the length of the RS is small, then it may be used for phase tracking.

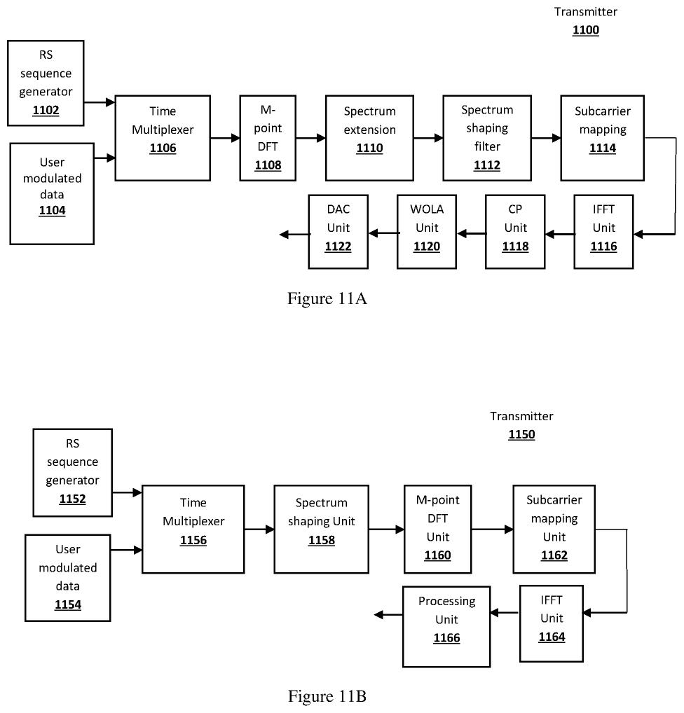

FIG. 11A shows a block diagram of transmitter illustrating multiplexing of Data and RS in one OFDM symbol, with spectrum shaping and excess bandwidth.

As shown in the FIG. 11A, the transmitter 1100, also referred as a communication system, comprises a RS sequence generator unit 1102, a user modulated data generation unit 1104, a time multiplexer 1106, an M-point discrete Fourier transform (DFT) unit 1108, a spectrum extension unit 1110, a spectrum shaping filter unit 1112, a subcarrier mapping unit 1114, an inverse fast Fourier transform (IFFT) unit 1116, symbol specific phase compensation (not shown in the figure), a cyclic prefix (CP) unit 1118, a WOLA (weighted with overlap and add operation) unit 1120, and an Digital to Analog converter (DAC) 1122. Also, the transmitter 1100 comprises a one or more antennas (not shown in the figure). The one or more transmitters are one of a plurality of antennas of a user, and one or more users, said each of the one or more users comprises one or more antennas, in an embodiment.

In an embodiment the transmitter is a base station (BS) or gNodeB or gNB. In an embodiment the transmitter is a user equipment or UE or user. The user modulated data generation unit 1104, also referred to as data generation unit or user data generator, generated data. The data may be one of a pi/2-binary phase shift keying (BPSK), a Quadrature Phase Shift Keying (QPSK), M-ary Phase Shift Keying (PSK), M-ary Quadrature Amplitude Modulation (QAM) sequence, or pulse amplitude modulation (PAM) modulation symbols. Also in an embodiment, the data is either related to control messages such as, but not limited to acknowledgement (ACK) or negative acknowledgement (NACK), a channel quality indicator (CQI) or transmitter specific information. The data of each transmitter may have no data-prefix or have data-cyclic prefix, data-cyclic suffix/post fix or both data-suffix and data-post fix. FIG. 10G shows symbol structure where data has both data-cyclic prefix and suffix. The length of RS is a function of Modulation Coding Scheme (MCS). Also, he RS may puncture data locations within 1 symbol, in an embodiment.

The data and the RS are time multiplexed using the time multiplexer 1106. For example, as shown in the FIG. 1, RS with RS-pre-fix and RS-post-fix is located at the center of the symbol, while the data occupies the starting and end positions of the symbol. The multiplexed symbol is represented by x′ (n), where n=0,1, . . . , M−1. A DFT precoding operation is applied on the multiplexed symbol through an M sized DFT 1108, as expressed below:

$$X ( k ) = \frac{1}{\sqrt{M}} {\sum }_{n = 0}^{M - 1} {x}^{′} ( n ) {e}^{- \frac{j 2 π kn}{M}}$$

In order to maintain the PAPR, the transmitter data used is a pi/2-BPSK modulated data, then pi/2-BPSK based reference sequences is used, so that phase continuity is maintained between the RS and transmitter pi/2-BPSK data. A spectrum extension is performed on the DFT pre-coded symbol using spectrum extension unit 1110, last d/2 samples of the pre-coded data are copied and placed at the beginning of the symbol as pre-fix and then the initial d/2 samples of the pre-coded data are copied and placed at the end of the symbol as post-fix, where d is the spectrum extension factor. This results in an OFDM symbol of size M+d, which is represented as,

$${X}_{exs} ( k ) = X ( ( k - \frac{d}{2} ) mod M )$$

Or the spectrum extension operation may be performed as below

$${X}_{exs} ( k ) = X ( ( k - K ) mod M )$$

where, k=0, 1, . . . , M+d−1, K may be some known shift or arbitrary shift which is a function of the allocation M. In an embodiment, the excess bandwidth (or excess subcarriers) used may be arbitrarily high and may be more than M subcarriers. The extension factor d is transmitter specific and may be same or different for multiple transmitters.

In a cellular system uplink, the additional bandwidth that needs to be used for spectrum extension is indicated to the UE (User Equipment) by the base station. The base station may indicate either extension on one side of the allocated bandwidth or two sides of the allocated bandwidth in steps of half PRB or one PRB. The signalling of the excess bandwidth may be done as a part of resource allocation. The Bandwidth extension on the either side of the allocated bandwidth may be almost equal such that the spectrum shaping filter is symmetric. The spectrum shaping filters 1112 may be generated to lengths that are greater than the spectrum extended symbol length and is truncated to get the shaping filter for the spectrum extended symbol. The spectrum extension may be asymmetric also, which means, the additional bandwidth on each side of the allocated bandwidth may be of different sizes. Alternately the gNB may indicate the transmitter 2 parameters—usable BW where data is allocated and excess BW where shaping is allowed. The gNB scheduler may take care of these 2 parameters per UE as part of the entire scheduling operations. The excess BW when symmetric is assumed to have equal guard subcarriers on either side of the allocated spectrum. However, for asymmetric cases, an additional parameter which indicates the start location of the usable BW is indicated between UE and gNB. The spectrum extension factor depends on channel properties, allocation size, modulation order, coding rate, and RS, CP lengths. Pi/2-BPSK modulation is a special case, where spectrum extension may not be needed. Spectrum shaping is performed on the spectrum extended data by multiplying with the frequency response of the spectrum shaping filter. The spectrum shaped data is given by,

$${X}_{ss} ( k ) = W ( k ) {X}_{exs} ( k )$$

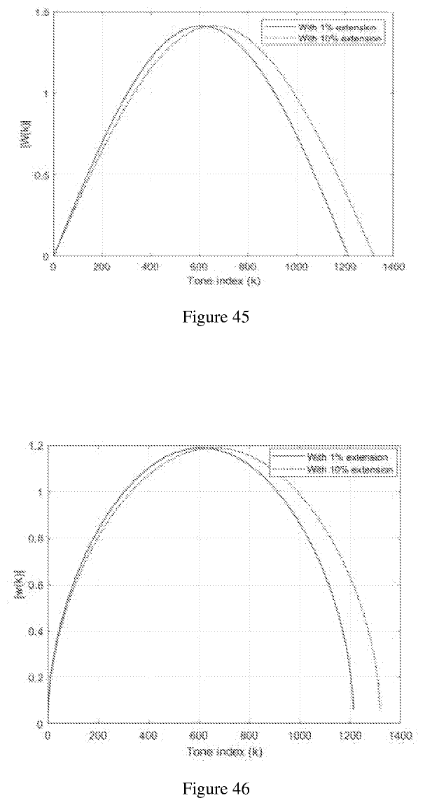

The filter W(k) is a frequency response of square root raise cosine, raised cosine, Hanning, Blackman or Hamming windows, or the filter is an oversampled Linearized Gaussian Minimal Shifting Keying (LGMSK) pulse. The frequency response of some of the spectrum shaping filters are shown in FIGS. 45, 47, and 49. Otherwise, filter W (k) may be a square root of the frequency response of the above-mentioned filters. The spectrum shaping filter is either specified by the base station or may be unknown at the base station. The spectrum shaping filter 1110 may be specified in the standard or specification transparent. The spectrum shaping filter may also be obtained by truncating the filter, that is generated to length greater than the size of the spectrum shaped data, to the size of the spectrum shaped data. The filter to be used is one of the filters mentioned above. The shaping filter 1112 for multiple transmitters may be same or different.

When spectrum extension factor ‘d’ is zero, no spectrum extension is performed, for example modulation schemes like pi/2-BPSK. In this case, the spectrum shaping is performed either in time-domain by circular convolving the data-RS multiplexed symbol with impulse response of the spectrum shaping filter or in frequency domain, where the DFT-pre-coded symbol is simply multiplied with the frequency response of the spectrum shaping filter. The spectrum shaping help in reduction of PAPR, which eventually results in better power efficiency.

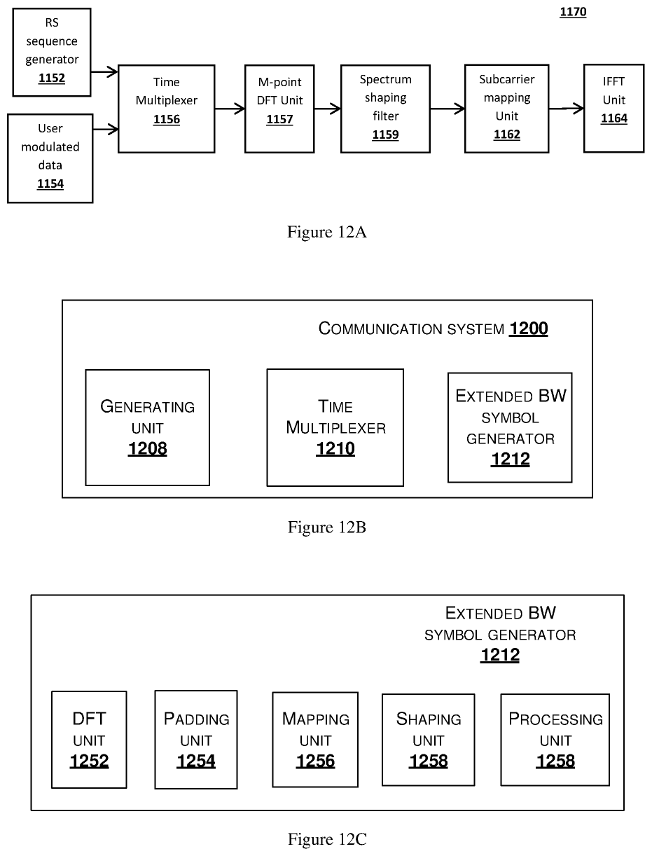

The spectrum shaped data is mapped on to the subcarriers allocated to the transmitter using the subcarrier mapping unit 1114 to generate mapped data. This is followed by an IFFT of size N to generate an OFDM waveform using the IFFT unit 1116 along with phase compensation for each symbol by multiplying with a symbol specific exponential value. This is further processed with at least one of symbol Cyclic Prefix (CP) addition using CP unit 1118, WOLA operation using WOLA unit 1120, windowing, bandwidth parts (BWP) rotation, additional time domain filtering, sampling rate conversion to match DAC rate and frequency shifting on the time domain waveform, DAC using the unit 1122. This symbol structure is referred as filtered-extended bandwidth DFT-s-OFDM symbol comprising of data and RS. If data is not present while generating the symbol, then it is referred as filtered-extended bandwidth DFT-s-OFDM symbol comprising full RS. If RS is not present while generating the symbol, then it is referred as filtered-extended bandwidth DFT-s-OFDM symbol comprising full data. Overall transmitter structure with spectrum extension is shown in FIG. 11A, and without extension are shown in FIGS. 11B and 12. In another embodiment the subcarrier mapping is performed followed by the spectrum shaping on the spectrum extended DFT precoded sequence.

FIG. 11B shows a block diagram of transmitter illustrating multiplexing of Data and RS in one OFDM symbol, with spectrum shaping in time-domain and without excess bandwidth in accordance with another embodiment of the present disclosure. As shown in the FIG. 11B, the transmitter 1150, also referred as a communication system, comprises a RS sequence generator unit 1152, a user modulated data generation unit 1154, a time multiplexer 1156, a spectrum shaping unit 1158, an M-point discrete Fourier transform (DFT) unit 1160, a subcarrier mapping unit 1162, an inverse fast Fourier transform (IFFT) unit and phase compensation 1164, and a processing unit 1166. The processing unit 1166 comprises at least one of a cyclic prefix (CP) unit, a WOLA (weighted with overlap and add operation) unit, bandwidth parts (BWP) rotation, additional time domain filtering, sampling rate conversion to match DAC rate and frequency shifting on the time domain waveform, and a Digital to analog converter (DAC). Also, the transmitter 1150 comprises a one or more antennas (not shown in the figure).

In an embodiment the transmitter is a base station (BS) or gNodeB or gNB. In an embodiment the transmitter is a user equipment or UE or user. The communication system or transmitter 1150 generates the waveform by performing time multiplexing of the RS and Data, followed by the shaping operation in time domain and then transforming the multiplexed sequence using the M-point DFT. The transformed sequence is mapped using the subcarrier mapping, followed by at least one of IFFT operation, phase compensation, symbol Cyclic Prefix (CP) addition, WOLA, BWP rotation, windowing, and DAC.

FIG. 12A shows a block of a transmitter illustrating multiplexing of Data and RS multiplexed in one OFDM symbol, with spectrum shaping in frequency-domain and without excess bandwidth, in accordance with another embodiment of the present disclosure.

As shown in the FIG. 12A, the transmitter 1170, also referred as a communication system, comprises a RS sequence generator unit 1152, a user modulated data generation unit 1154, a time multiplexer 1156, an M-point discrete Fourier transform (DFT) unit 1157, a spectrum shaping filter 1159, a subcarrier mapping unit 1162, an inverse fast Fourier transform (IFFT) unit 1164, a phase compensation unit (not shown in the figure) and a processing unit (not shown in the figure). The processing unit comprises at least one of a cyclic prefix (CP) unit, a WOLA (weighted with overlap and add operation) unit, and a digital to analog converter (DAC). Also, the transmitter 1170 comprises a one or more antennas (not shown in the figure).

In an embodiment the transmitter is a base station (BS) or gNodeB or gNB. In an embodiment the transmitter is a user equipment or UE or user. The communication system or transmitter 1170 generates the waveform by performing time multiplexing of the RS and Data to obtain time multiplexed symbol. The time multiplexed symbol is transformed using the M-point DFT followed by the filtering or shaping operation. The filtered transformed sequence is mapped using the subcarrier mapping, followed by at least one of IFFT operation, phase compensation, symbol Cyclic Prefix (CP) addition, WOLA, bandwidth parts (BWP) rotation, windowing, and DAC.

In an embodiment, the multiplexed pilots with the data are referred as data streams. The data streams may be configured to be transmitted over one or more corresponding channels. For every channel, one or more antennas may be used. Thus, for every channel, a DFT-s-OFDM symbol is generated.

FIG. 12B shows a block diagram of a transmitter in a communication network, in accordance with an exemplary embodiment of the present disclosure. FIG. 12C shows a block diagram of extended BW symbol generator, in accordance with an embodiment of the present disclosure;

FIG. 12B shows a block diagram of a communication system in a communication network, in accordance with an embodiment of the present disclosure. The communication system 1200 generates a waveform for transmission.

As shown in FIG. 12B, the communication system 1200 comprises a processor, and memory coupled with the processor (not shown in the figure). The communication system may be referred as a transmitter. In an embodiment the communication system is a base station (BS) or gnB. In an embodiment the communication system is a user equipment (UE). The processor may be configured to perform one or more functions of the communication system for communication in the communication network. In one implementation, the communication system/transmitter 1200 comprises blocks, also referred as modules or units for performing various operations in accordance with the embodiments of the present disclosure. In an embodiment, the communication system 1200 comprises one or more transmitters or antennas also referred as plurality of transmitters or antennas (not shown in the Figure).

The communication system 1206 includes a generating unit 1208, a time multiplexer 1210, an extended bandwidth (BW) symbol generator 1212 and one or more transmitters (not shown in the figure). The generating unit 1208 generates at least one data sequence and at least one reference sequence (RS). The at least one data sequence is one of a pi/2 binary phase shift keying (BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence. In an embodiment, the at least one data sequence includes at least one of a user data and a control information. Each of the at least one data sequence includes at least one data, and at least one of a data cyclic prefix and a data cyclic suffix. In an embodiment, length of the data or control information is at least one 1 sample.

In an embodiment, the at least one RS comprises one or more transmitter specific RS repetitions associated with each of the one or more transmitters. The at least one RS is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence.

In an embodiment, each of the at least one RS sequence includes at least one RS block, at least one of a RS cyclic prefix and a RS cyclic suffix, size of the RS cyclic prefix is one of at least half of the RS block size and an arbitrary value, size of the RS cyclic suffix is one of at least half of the RS block size and an arbitrary value. The arbitrary value is 0 or ¼th of RS block size or any other value which may be pre-defined in specification or explicitly signalled between transmitter or receiver or implicitly understood based on the size of the RS.

In an embodiment, when the at least one data and at least one RS sequence are pi/2-BPSK sequence, then the multiplexed sequence is rotated by 90 degrees between successive elements of the multiplexed sequence to generate a rotated multiplexed sequence.

In an embodiment, each of the plurality of transmitter specific RS blocks is multiplied with a transmitter specific code cover. The transmitter specific code cover is a sample based code cover. The at least one RS is a sequence of samples, each sample is multiplied with an element of a transmitter specific phase ramp sequence. The one or more transmitter specific RS is a sequence of samples, said each sample is multiplied with an element of a transmitter specific phase ramp sequence. The at least one RS is multiplied with element by element. In an embodiment, the phase ramp sequence is called sample wise code cover.

In another embodiment, the transmitter specific code cover is a RS block wise code cover. The transmitter specific code covers are orthogonal to each other. The transmitter specific code cover is one of a binary phase shift keying (BPSK) sequence, an exponential sequence, a Walsh Hadamard sequence, PN sequences and DFT sequence. Examples of DFT sequences are [1−1], [1−1−j 1], [−1 1], [1−1 1−1], [1 j−j 1]. Here j=\sqrt{−1}.

In an embodiment, the transmitter specific code cover is dependent on a transmitter specific RS antenna port. Each of the one or more transmitter specific RS is cyclic shifted sequence of a base sequence.

The time multiplexer 1210 performed time-multiplexing of the at least one data sequence with the at least one RS, to generate a multiplexed sequence. The extended bandwidth (BW) symbol generator 1212 generates a filtered-extended bandwidth DFT-s-OFDM symbol using the multiplexed sequence. The filtered-extended bandwidth DFT-s-OFDM symbol generated by the one or more transmitters are transmitted in an OFDM symbol/slot at the same time instant. FIG. 12C shows a block diagram of extended BW symbol generator, in accordance with an embodiment of the present disclosure. In an embodiment, the filtered-extended bandwidth DFT-s-OFDM symbol includes a plurality of RS blocks, wherein size of the plurality of RS blocks is different. In an embodiment, the filtered-extended bandwidth DFT-s-OFDM symbol includes a plurality of RS blocks, wherein the size of the plurality of RS blocks is same.

In an embodiment, a filtered-extended bandwidth DFT-s-OFDM full RS symbol is generated for the multiplexed sequence comprising of at least one RS sequence. Similarly, a filtered-extended bandwidth DFT-s-OFDM full data symbol is generated for the multiplexed sequence comprising of at least one data sequence.

As shown in FIG. 12C, the extended BW symbol generator 1212 comprises a Discrete Fourier Transform (DFT) unit 1252, a padding unit 1254, a mapping unit 1256, a shaping unit or a filter 1258 and a processing unit 1260.

The DFT 1252 transforms the multiplexed sequence received from the time multiplexer 1210 using a Discrete Fourier Transform (DFT) to generate a transformed multiplexed sequence.

The padding unit performs padding operation on the transformed multiplexed sequence i.e. prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero. The values of N1 and N2 may be same or different. The value of N1 and N2 may depend on the excess power that is sent by the transmitter. In an embodiment, the transmitter is user equipment (UE) or base station (BS).

The mapper 1256, also referred as a sub carrier mapper or mapping unit or subcarrier mapping unit, performs subcarrier mapping on the extended bandwidth transformed multiplexed sequence with at least one of localized and distributed subcarriers to generate a mapped extended bandwidth transformed multiplexed sequence. In an embodiment, the distributed subcarrier mapping includes insertion of zeros in to the extended bandwidth transformed multiplexed sequence.

The shaping unit 1258, also referred as a filter, performs shaping of the mapped extended bandwidth transformed multiplexed sequence to obtain a shaped extended bandwidth transformed multiplexed sequence. The filter used for the shaping operation on the extended bandwidth transformed multiplexed sequence is one of a Nyquist filter, square root raised cosine filter, a raised cosine filter, a hamming filter, a Hanning filter, a Kaiser filter, an oversampled GMSK filter and any filter that satisfies predefined spectrum characteristics.

The processing unit 1258 performing an Inverse Fast Fourier Transform (IFFT) on the shaped extended bandwidth transformed multiplexed sequence to produce a time domain sequence and processing the time domain sequence to generate the filtered-extended bandwidth DFT-s-OFDM symbol. The processing of the time domain sequence to generate a filtered-extended bandwidth DFT-s-OFDM symbol comprises performing at least one of a symbol specific phase compensation, an addition of symbol cyclic prefix, addition of symbol cyclic suffix, windowing, weighted with overlap and add operation (WOLA), bandwidth parts (BWP) rotation, an additional time domain filtering, sampling rate conversion to match DAC rate, frequency shifting on the time domain waveform and a digital to analog converter (DAC), to generate the filtered-extended bandwidth DFT-s-OFDM symbol.

In an embodiment, the generated filtered-extended bandwidth DFT-s-OFDM symbol transmission is a single shot transmission comprising at least one RS sequence, and at least one of data and control sequence and the said RS sequence is used to demodulate the said data or control sequence.

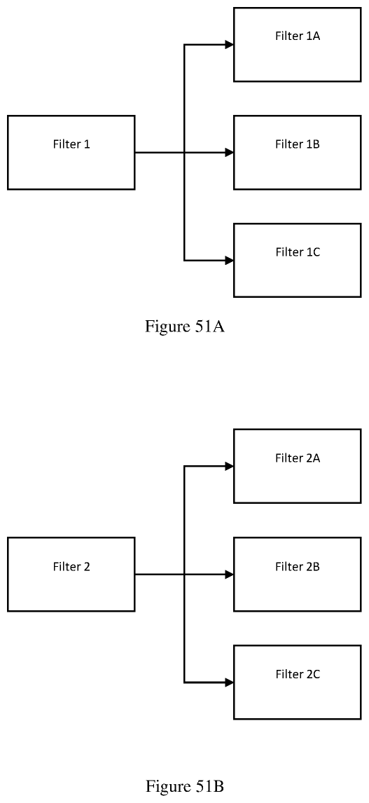

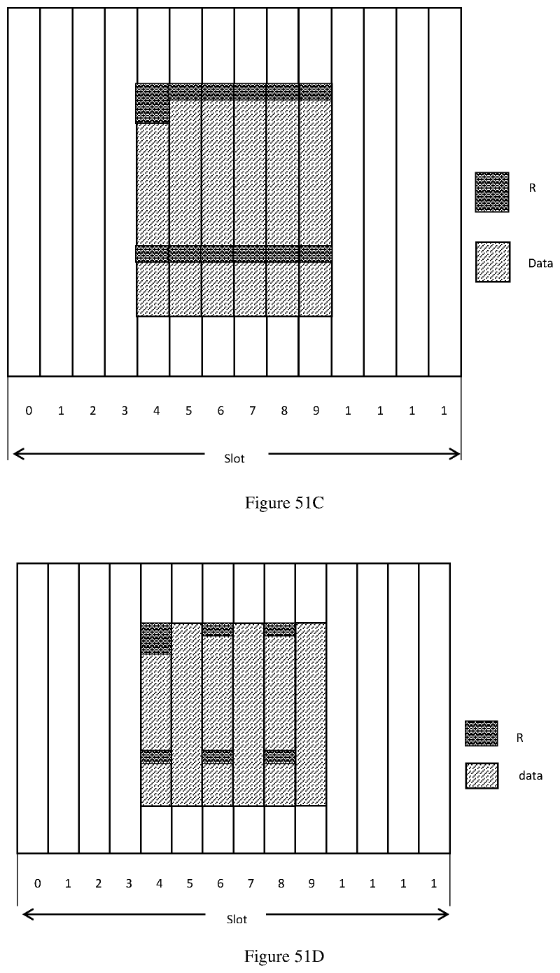

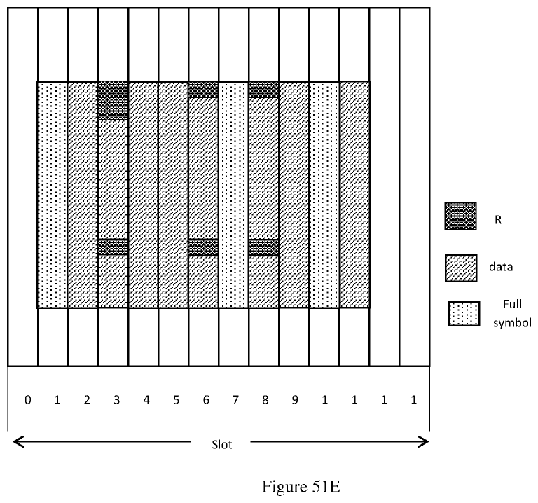

The transmission of the waveform being generated is being performed using a slot. The slot comprises a plurality of OFDM symbols, said plurality of OFDM symbols includes at least one of: at least one filtered-extended bandwidth DFT-s-OFDM symbol comprising of RS and data, at least one filtered-extended bandwidth DFT-s-OFDM symbol comprising of full RS, and at least one filtered-extended bandwidth DFT-s-OFDM symbol comprising of full data. The plurality of OFDM symbols includes at least one of a filtered-extended bandwidth DFT-s-OFDM symbol comprising of RS and data is filtered using a first filter, filtered-extended bandwidth DFT-s-OFDM symbol comprising of RS is filtered using a second filter, filtered-extended bandwidth DFT-s-OFDM symbol comprising of data is filtered using a third filter, said filter have one on one correspondence among each other. The coefficients of the filters are the same. The filters are depicted in FIGS. 51A, 51B.

FIGS. 51A and 51B shows an illustration of a first filter and a second filter of a transmitter respectively, in accordance with an embodiment of the present disclosure. As shown in FIG. 51A, three filters i.e. filter 1A, filter 1B, and filter 1C are corresponding to filter 1. The three filters are used for filtering the one of filtered-extended bandwidth DFT-s-OFDM symbol comprising RS and data, filtered-extended bandwidth DFT-s-OFDM symbol comprising only data, filtered-extended bandwidth DFT-s-OFDM symbol comprising only RS, while the filters are in correspondence to each other and filter 1. As shown in FIG. 51B, three filters i.e. filter 2A, filter 2B, and filter 2C are corresponding to filter 2 and used for filtering the one of filtered-extended bandwidth DFT-s-OFDM symbol comprising RS and data, filtered-extended bandwidth DFT-s-OFDM symbol comprising only data, filtered-extended bandwidth DFT-s-OFDM symbol comprising only RS, while the filters are in correspondence to each other and filter 2. In another embodiment, the filter 1 and filter 2 of FIGS. 51A and 51B may have at least two corresponding filters.

In an embodiment, the at least one RS is placed at one of starting position of the multiplexed sequence, ending position of the multiplexed sequence, at both the starting position and ending position of the multiplexed sequence, and at centre position of the multiplexed sequence.

The plurality of OFDM symbols includes at least one of a filtered-extended bandwidth DFT-s-OFDM symbol comprising of RS and data is filtered using a first filter, filtered-extended bandwidth DFT-s-OFDM symbol comprising of RS is filtered using a second filter, filtered-extended bandwidth DFT-s-OFDM symbol is filtered using a third filter, said filter have one on one correspondence. The same is depicted in FIGS. 51A, 51B. As shown in FIG. 51A, three filters i.e. filter 1A, filter 1B, and filter 1C corresponding to filter 1 are used for filtering the one of filtered-extended bandwidth DFT-s-OFDM symbol comprising RS and data, filtered-extended bandwidth DFT-s-OFDM symbol comprising only data, filtered-extended bandwidth DFT-s-OFDM symbol comprising only RS, while the filters are in correspondence to each other and filter 1. Also as shown in FIG. 51B, three filters i.e. filter 2A, filter 2B, and filter 2C corresponding to filter 2 and used for filtering the one of filtered-extended bandwidth DFT-s-OFDM symbol comprising RS and data, filtered-extended bandwidth DFT-s-OFDM symbol comprising only data, filtered-extended bandwidth DFT-s-OFDM symbol comprising only RS, while the filters are in correspondence to each other and filter 2.

One embodiment of the present disclosure is a receiver. At the receiver, the received signal is first processed with front processing elements like an analog to digital convertor (ADC), a cyclic prefix (CP) removal, a phase de-rotation or decompensation and a Fast Fourier Transform (FFT). The allocated sub-carriers are de-mapped in the sub-carrier de-mapper, where M+d allocated sub-carriers are de-mapped from entire FFT output. If spectrum shaping performed at the transmitter is with square root of the frequency response of the spectrum shaping filter and/or filter is known at the receiver, then de-mapped “M+d” subcarriers are multiplied with the same filter used at the transmitter before further processing. This helps in maximizing the receiver SNR. If the filter is not known at the receiver, then the de-mapped data is processed without any receiver shaping. The filter used at the receiver is called as “subcarrier filters”. The subcarrier filter is one of SQRC, RC, Hanning, Hamming, Blackman, or LGMSK pulses, or square root of these pulses. The filter may be obtained by generating the filter using one of the above-mentioned filters to lengths greater than M+d, and truncating the generated filter to M+d length. The frequency response of some of the subcarrier filters are shown in FIGS. 45 to 50.

The spectrum shaping filter used by the transmitter and receiver are the same and is indicated (or pre-determined/a priori agreed) between the UE and BS. One example of such a filter is square root raised cosine pulse which is applied in the frequency domain (in both Tx and Rx sides).

From M+d size de-mapped data Y(k), M samples are obtained either by picking the central M samples or using one of the two identical methods by folding the spectrum. In the first method, M samples are obtained from M+d samples by taking modified IDFT of size M, which is given by the following expression.

$$\tilde{Y} ( k ) = \frac{1}{\sqrt{M}} {\sum }_{k = 0}^{M + d - 1} Y ( k ) {e}^{\frac{j 2 π ( k - \frac{d}{2} ) n}{M}}$$

The second method, which is equivalent to the above expression involves the following steps.

From the de-mapped data Y(k), central M-subcarriers are collected and labelled as Y₁(k).

The de-mapped data is left shifted by M-subcarriers to collect central M-subcarriers which is labelled as Y₂(k).

The de-mapped data is right shifted by M-subcarriers to collect central M-subcarriers which is labelled as Y₃(k).

Effective received data of size M is obtained by adding all the above collected data. The effective data is given by the expression:

$$\tilde{Y} ( k ) = {Y}_{1} ( k ) + {Y}_{2} ( k ) + {Y}_{3} ( k )$$

This procedure is encapsulated in the FIG. 14. In cases where the excess number of subcarriers is more than M, additional circularly shifted components (2M, 3M etc) will be included in the above expression.

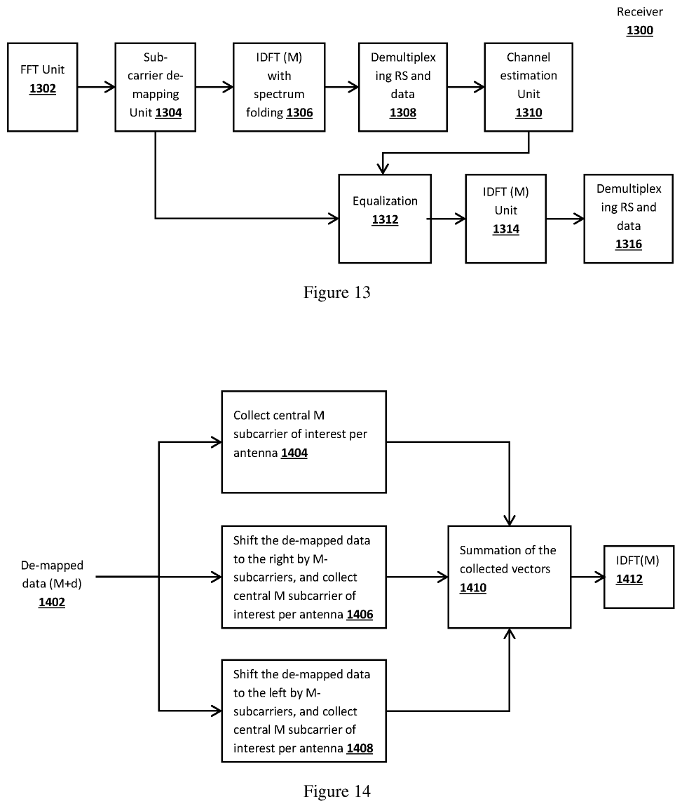

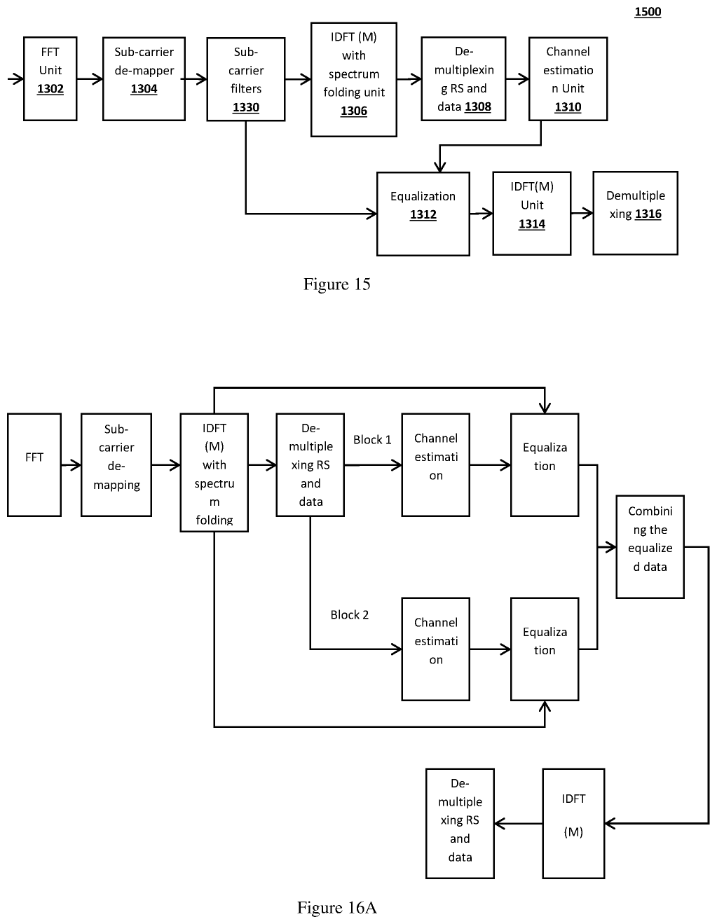

An IDFT of size M is taken over the effective data Y(k) to obtain the received data in time-domain, where Data and RS are de-multiplexed. The received RS samples are used for channel estimation. Estimation may be performed by Least Squares method, or Least Squares followed by time-domain interpolation. The estimated channel obtained from RS will be used for equalizing the de-mapped data of size M using an equalizer like MMSE. An IDFT of size M is performed on the equalized data to obtain multiplexed RS and data in time-domain. Each transmitter data is de-multiplexed and sent for further processing. The receiver architecture for this is as shown in FIG. 13. The receiver architecture for receiver filtering is as shown in FIG. 15. If spectrum extension is not performed at the transmitter, An IDFT of size M is performed on the de-mapped without any intermediate processing.

FIG. 13 shows a block diagram of a receiver for receiving Data and RS multiplexed in one OFDM symbol, with spectrum shaping and excess bandwidth. FIG. 14 an illustration of obtaining M samples from M+d samples. FIG. 15 shows a receiver receiving for Data and RS multiplexed in one OFDM symbol with spectrum extension shaping and receiver spectrum shaping.

When multiple RS blocks with either RS-CP/CS or both with RS-CP and RS-CS are transmitted, channel estimation is performed on all the transmitted RS blocks. The estimated channel on each block will be used for equalizing the transmitter data transmitted adjacent to that. The receiver architecture for this is as shown in FIG. 16A.

FIG. 16A shows a block diagram of a receiver for receiving two RS blocks, with estimation on each RS block. The receiver architecture may be extended for any number of blocks. In the receiver, the received data is first processed with a CP removal, a phase decompensation and an FFT. The FFT output data is used to demap the transmitter specific samples which is of size M+d. The demapped M+d data is either selected or folded to get an output of M samples. An IDFT of size M is applied on the obtained M samples. From the IDFT output the available RS sequences are used for channel estimation. The channel estimated using the available RS sequences are used to equalize the received data adjacent to the RS block. In an embodiment, the RS block may be a different RS sequence or same RS sequence. The said RS sequence may be placed adjacent to each other or separately within an OFDM symbol. In an embodiment, the RS block may be a different of same size or different size.

The equalized data from both the RS block to get the effective equalized data. However, when multiple blocks of different sizes are transmitted, the block with larger size will be used for channel estimation, which will have used for symbol equalization. The smaller blocks are used to estimate any phase changes in the equalized data. The receiver architecture for this is as shown in FIG. 16B. The receiver architecture is for two blocks; however, it may be extended for any number of blocks. FIG. 16B shows a receiver for receiving two RS blocks, with phase estimation on secondary RS block. In the receiver, the received data is first processed with CP removal, phase decompensation and FFT. The FFT output data is used to demap the transmitter specific samples which is of size M+d. The demapped M+d data is either selected or folded to get an output of M samples. From the M samples, the larger size RS blocks are used to estimate the channel estimation. The estimated channel is used to equalize the received M sample data. An IDFT on the equalized data is performed to obtain the smaller size RS blocks. The smaller size RS blocks will be used for estimation of the phase changes in the equalized data, which eventually used to correct the equalized data.

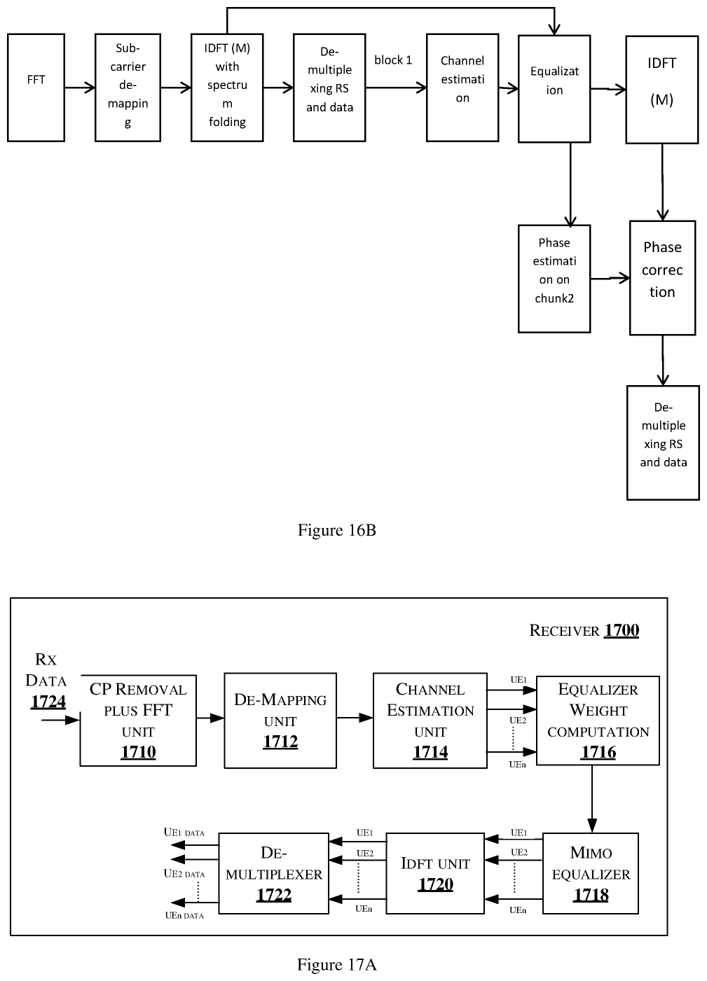

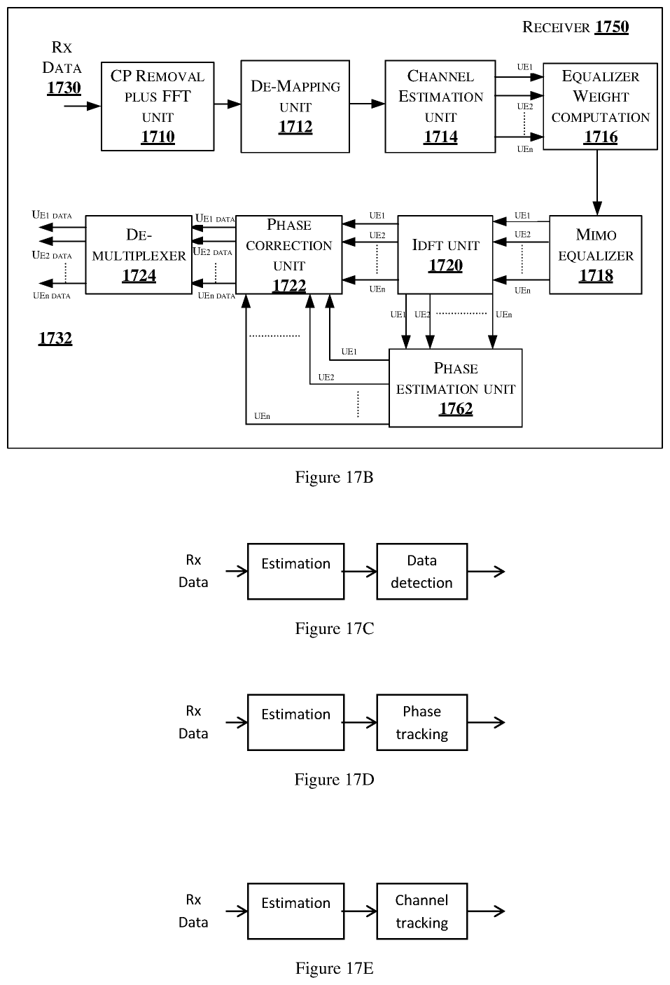

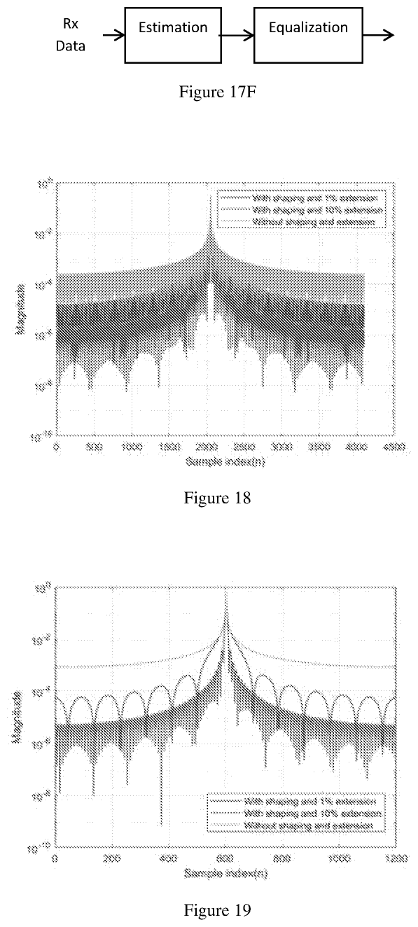

FIG. 17A show block diagram of a receiver for detecting the received data, in accordance with an embodiment of the present disclosure.

FIG. 17A show block diagram of a receiver for detecting the received data of multiple transmitters, in accordance with an embodiment of the present disclosure. The receiver 1700 comprises a cyclic prefix (CP) removal plus fast Fourier transform (FFT) unit 1710, a phase decompensation/de-rotation unit (not shown in the figure), a de-mapping unit 1712, a channel estimation unit 1714, equalizer weight computation unit 1716, MIMO equalizer 1718, an inverse discrete Fourier transform (IDFT) unit 1720, and a de-multiplexer 1722. At the receiver 1700 as shown in the FIG. 17A, the received data 1724 is first processed with CP removal and FFT using the CP removal plus FFT unit 1710. The FFT output is operated with phase decompensation (not shown in figure). In the demapping unit 1712, the FFT output is processed with demapping the mapped M+d data and obtaining M samples from M+d data either with folding the M+d to obtain M samples or by picking any M samples form the M+d samples. In the demapping unit, the demaped M+d samples may be matched with the transmitted shaping filter, if the shaping filter is known at the receiver. These filters are subcarrier filters which may be one of SQRC, RC, 2-tap, 3-tap, or over sampled LGMSK pulse. The subcarrier filters may be square root on one of the above-mentioned filter, or the subcarrier filters may be obtained by generating the mentioned filter with or without square root of the mentioned filters to lengths greater than the M+d, and then truncating the filters to M+d samples. From the M samples, one of the transmitted RS sequences is processed with channel estimation unit 1714 to obtain transmitter specific channel estimates. The transmitter specific channel estimates may be obtained by performing one of Least squares, or MMSE or LS followed by interpolation. The channel estimation procedure depends on the type of the transmitter multiplexing used at the transmitter. The estimation may be performed with every possible RS sequence transmitted by the transmitters or by using only one RS sequence. The RS sequence used for channel estimation may be the largest possible main RS sequence. The estimated transmitter specific channel estimates may be used for obtaining the equalizer weights using the equalizer weight computation unit 1716. The equalizer to be used may be linear equalizers like zero forcing, Matched filtering, MMSE or non-linear equalizers also. The equalizer output will be transmitter specific, which will be operated with IDFT and demultiplexing transmitter specific data.

FIG. 17B show block diagram of a receiver for detecting the received data of multiple transmitters along with phase correction module for the equalized data, in accordance with another embodiment of the present disclosure.

The receiver 1750 comprises a cyclic prefix (CP) removal, phase decompensation and fast Fourier transform (FFT) unit 1710, a de-mapping unit 1712, a channel estimation unit 1714, equalizer weight computation unit 1716, MIMO equalizer 1718, an inverse discrete Fourier transform (IDFT) unit 1720, a phase estimation unit 1762, a phase correction unit 1722 and a de-multiplexer 1724. At the receiver as shown in the FIG. 1750, the received data 1730 is first processed with CP removal phase decompensation and FFT using the unit 1710. In the demapping unit 1712, the FFT output is processed with demapping the mapped M+d data and obtaining M samples from M+d data either with folding the M+d to obtain M samples or by picking any M samples form the M+d samples. In an embodiment at the demapping unit 1712, the demaped M+d samples may be matched with the transmitted shaping filter, if the shaping filter is known at the receiver. These filters are subcarrier filters which may be one of SQRC, RC, 2-tap, 3-tap, or over sampled LGMSK pulse. The subcarrier filters may be square root on one of the above-mentioned filter, or the subcarrier filters may be obtained by generating the mentioned filter with or without square root of the mentioned filters to lengths greater than the M+d, and then truncating the filters to M+d samples. From the M samples, one of the transmitted RS sequence is processed with channel estimation unit to obtain transmitter specific channel estimates. The transmitter specific channel estimates may be obtained by performing Least squares, or MMSE or LS followed by interpolation. The channel estimation unit 1714 performs channel estimation procedure depends on the type of the transmitter multiplexing used at the transmitter. The estimation may be performed with every possible RS sequence transmitted by the transmitters or by using only one RS sequence. The RS sequence used for channel estimation may be the largest possible main RS sequence.

The estimated transmitter specific channel estimates may be used for obtaining the equalizer weights using the equalizer weight computation unit 1716. The MIMO equalizer 1718 is a linear equalizer such as zero forcing, Matched filtering, MMSE or non-linear equalizers. The MIMO equalizer 1718 output will be transmitter specific, which will be operated with IDFT to obtain time domain the transmitter specific transmit data. From the transmitter specific IDFT output smaller RS sequences, which is of size minimum of one sample will be used for phase estimation for corresponding transmitter. The transmitter specific estimated phase or phase estimation unit 1762 is used to phase correct the transmitter IDFT output data. From the phase corrected transmitter specific data, data is de-multiplexed and sent for further processing using the phase correction unit 1722 and de-multiplexer 1742 to obtain the transmitter specific data 1732.

FIG. 17C shows a block diagram of a receiver for estimation and data detection. As shown in FIG. 17C the receiver receives the received data, wherein estimation may be performed using one of the transmitted RS, which may be at least one of filtered-extended bandwidth DFT-s-OFDM symbol comprising RS and data and filtered-extended bandwidth DFT-s-OFDM symbol comprising full RS. The estimated channel may be used for detection of data on interest.

FIG. 17D shows a block diagram of a receiver for estimation and phase tracking. As shown in the FIG. 17D the receiver receives the received data, wherein estimation may be performed using one of the transmitted RS, which may be at least one of filtered-extended bandwidth DFT-s-OFDM symbol comprising RS and data, and filtered-extended bandwidth DFT-s-OFDM symbol comprising full RS, filtered-extended bandwidth DFT-s-OFDM symbol comprising full data and carrying smaller RS also. The smaller RS may be used for phase tracking.

FIG. 17E shows a block diagram of a receiver for estimation and channel tracking. As shown in the FIG. 17E the receiver receives the received data, wherein estimation may be performed using one of the transmitted RS, which may be at least one of filtered-extended bandwidth DFT-s-OFDM symbol comprising RS and data, and filtered-extended bandwidth DFT-s-OFDM symbol comprising full RS, filtered-extended bandwidth DFT-s-OFDM symbol comprising full data and carrying smaller RS also. The smaller RS may be used for channel tracking.

FIG. 17F shows a block diagram of a receiver for estimation and equalization. As shown in the FIG. 17F the receiver receives the received data, wherein estimation may be performed using one of the transmitted RS, which may be at least one of filtered-extended bandwidth DFT-s-OFDM symbol comprising RS and data, and filtered-extended bandwidth DFT-s-OFDM symbol comprising full RS, filtered-extended bandwidth DFT-s-OFDM symbol comprising full data. The estimated channel may be used to equalize the received data.

One embodiment of the present disclosure is results in AWGN delay channel (timing error). FIG. 18 shows a plot illustrating an effective channel on the OFDM symbol post CP removal at the receiver. FIG. 19 shows a plot illustrating an effective channel on the OFDM symbol post IDFT at the receiver.

FIGS. 18 and 19 show the effective time channel on the OFDM symbol post CP removal and post IDFT at the receiver. The effective channel is without shaping, and with SQRC shaping. From the figures, it can be inferred that, without spectrum shaping the channel energy is spread over the entire allocation. While with shaping the energy starts getting concentrated around the main lobe. Additionally, with increase in the excess bandwidth, the length of the spectrum shaping filter increases, which eventually results in more concentration of energy in the main lobe. Hence, with the decrease in the side lobes energy, there will be less leakages of data on to RS, and a lesser number of RS samples will be needed for perfect channel estimation compared to without shaping.

In an embodiment for data transmission of 1 or 2 bit and BPSK spreading of BPSK/QPSK constellation points data is mapped to BPSK or QPSK), considering signalling from a base station (BS) i.e. a transmitter, which is any of the communication systems as shown in FIGS. 11A, 11B and 12 to user equipment (UE), which is a receiver. A code, also referred as sequence, allocation is performed across plurality of BSs, also referred as multiple sectors or BSs, to reduce interference. The BSs may use a combination of code allocation and different frequency resources to the users to reduce interference. Let an input sequence from a BS, be a BPSK sequence which is communicated to a UE through two indices, first index and second index. The first index may indicate cell/BS specific index and second index is a shift. In an embodiment, there may be N base sequences and L shifts. Upon allocation of a base sequence by the BS to the UE, that is determined by an index, wherein the index values may be 1, 2, . . . , N, the BPSK code cover may be obtained by shifting the base sequence circularly with a shift that is indicated to the UE. The shift may take one of L values.

One embodiment of the present disclosure is user multiplexing i.e. 1 or 2-bit control information may be transmitted over multiple OFDM symbols while code multiplexing multiple user using the communication system/transmitter. Let C (i, j) denote a length M code where M is the occupies number of subcarriers, for example M=12. The index i is the first index (base sequence index) that takes values 1, 2, . . . , N and index j is the second index that indicates a shift applied to base sequence that takes values in the range j=1, 2, . . . , L. In an embodiment, the communication is a base station (BS), which may multiplex users in the same time frequency resources i.e. M subcarriers of an OFDM symbols by assigning different values of i and j among users. The values of i and j may be chosen such that allocated sequences are orthogonal between multiplex users. The BS may assign same value of first index to all multiplexed users but different values of j (shifts) in one OFDM symbols. For example, the maximum number of multiplexed users is 6.

In an embodiment, considering user multiplexing capacity is less than 6, a BS may multiplex less than 6 users on the same resource. In such a scenario, the available second indices (shifts) may be used in other cells/BSs. More specifically, two or three adjacent sectors may use the same first index (base sequence) and distinct second indices (shifts) so that control transmissions across three sectors are orthogonal in three sectors. This may be achieved by assigning same first index of base sequence to all three sectors and further allocate shifts (1,2) in first sector, shifts (3,4) in second sector and shifts (5,6) in another sector where each sector multiplexes two users in the same OFDM symbols.

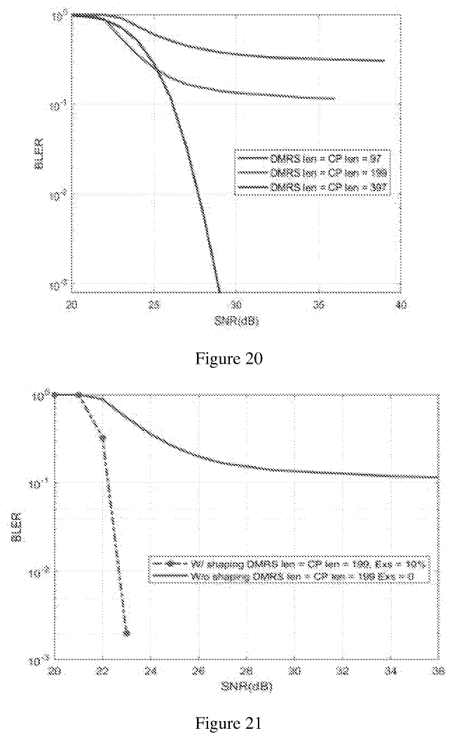

FIG. 20 shows an illustration of BLER performance of Pre-DFT RS and data multiplexing without spectral extension and shaping for allocation of 1200 subcarriers in one sample delay channel. Since, without spectral extension and shaping, there are significant channel taps on all the time domain samples. Hence, BLER performance highly depends on the RS+CP length, with increase in RS sizes, the number of channel taps that may be collected increase. This eventually results in better of BLER performance. Similar effect may be seen from the FIG. 31, where, with lesser RS size, there is error floor. However, with increase in the RS and CP lengths, there is improvement in the BLER performance. No error floor is observed only when RS+CP lengths are almost the size of the allocation.

However, like explained previously, with spectrum shaping, the channel energy gets concentrated in the main lobe. Hence, the effect of shaping is seen in the BLER performance as shown in FIG. 21. The FIG. 21 shows a plot illustrating BLER performance comparison in delay 1/1200 channel, with and without spectrum extension and shaping. For a give RS and CP sizes, with extension and shaping, there is no error floor is observed. Hence, the BLER performance is better compared to without extension and shaping.

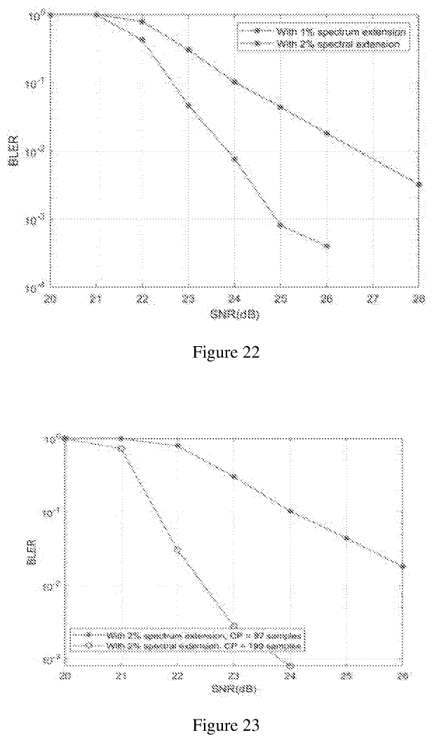

FIG. 22 shows a plot illustrating BLER performance comparison in delay 5/1200 channel, with different spectrum extension values and same RS, CP lengths. As shown in FIG. 22, the BLER performance of proposed system in 5 samples delay channel with same RS, CP length and different spectrum extension factors. From FIGS. 18 and 19, it may be observed that, the channel concentration in the mail lobe depends on the spectrum extension factor. Hence, for a given channel and given RS lengths, larger the spectrum extension factor, better will be the BLER performance compared to the lower extension values, which similar to performances shown in FIG. 23.

FIG. 23 shows a plot illustrating BLER performance comparison in delay 5/1200 channel, with same spectrum extension values and different RS, CP lengths. As shown in FIG. 23, the BLER performance of proposed system with same spectrum extension factor and different RS lengths. For a given extension factor, with increase in the RS size, more channel taps are captured in the estimated channel, which results in better estimation and BLER performance. Hence, with RS size of 199 samples has better performance compared to RS size of 97 samples for the same spectrum extension factor of 2%.

FIG. 23 shows an effective channel on the OFDM symbol post CP removal at the receiver for TDL-C 100 nsec.

One embodiment of the present disclosure is results with TDL channel model.

FIG. 25 shows a plot illustrating an Effective channel on the OFDM symbol post IDFT at the receiver for TDL-C 100 nsec.

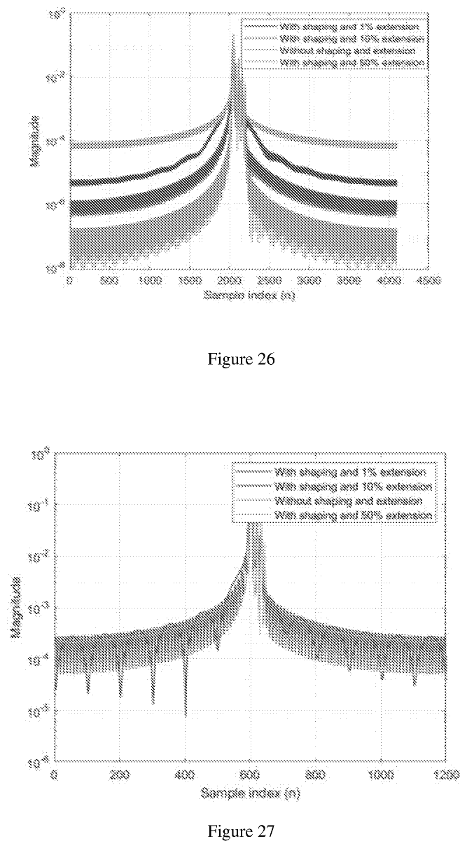

FIG. 26 shows a plot illustrating an Effective channel on the OFDM symbol post cp removal at the receiver for TDL-C 300 nsec.

FIG. 27 shows a plot illustrating an Effective channel on the OFDM symbol post IDFT at the receiver for TDL-C 300 nsec.

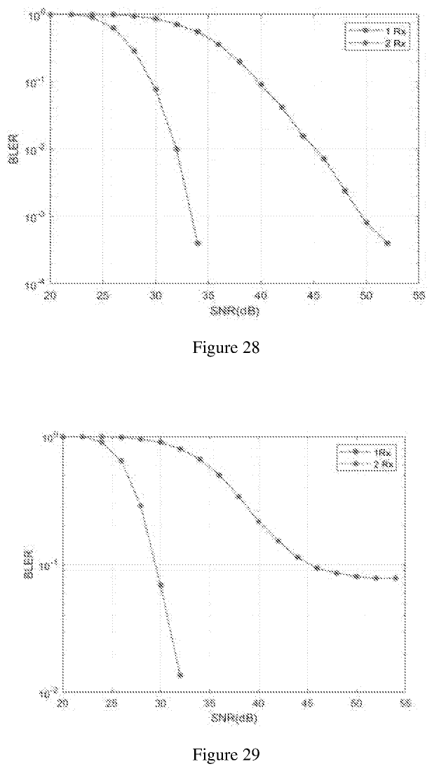

FIG. 28 shows a plot illustrating an BLER performance in TDL-C 100 nsec with 28% RS+CP OH for 1×1 and 2×1 systems and 256 QAM, R=0.89 (M=1200), 10% extension.

FIG. 29 shows a plot illustrating an BLER performance in TDL-C 300 nsec with 32% RS+CP OH for 1×1 and 2×1 systems and 256 QAM, R=0.89 (M=1200), 10% extension.

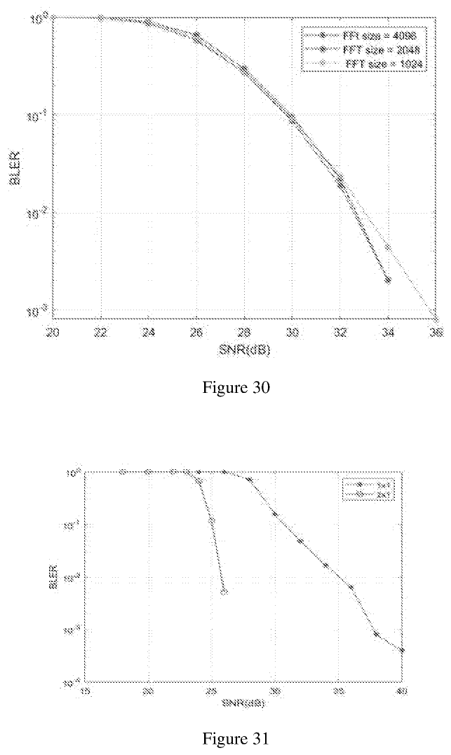

FIG. 30 shows a plot illustrating BLER performance in TDL-C 100 nsec with 20% RS+CP OH for 2×1 system and 256 QAM and R=0.89 with different FFT sizes (M=600), 10% extension.

FIG. 31 shows a plot illustrating an BLER performance in TDL-E 100 nsec with 28% RS+CP OH for 1×1 and 2×1 system and 256 QAM, R=0.89 with different FFT sizes (M=1200), 10% extension.

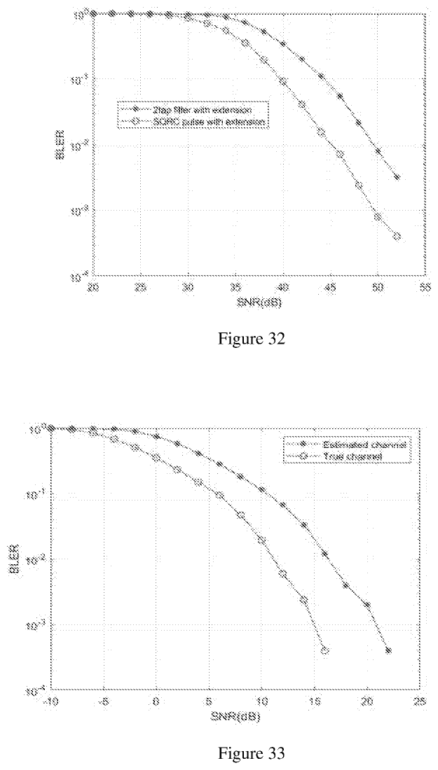

FIG. 32 shows a plot illustrating BLER performance in TDL-E 100 nsec with 28% RS+CP OH for 2×1 stem and 256 QAM, R=0.89 comparing SQRC and 2-tap filters (M=1200), 10% extension.

FIG. 33 shows a plot illustrating BLER performance in TDL-C 100 nsec with 21% RS+CP OH for 1×1 system and pi/2-BPSK modulation comparing true channel and estimated channel (M=1200), 10% extension.

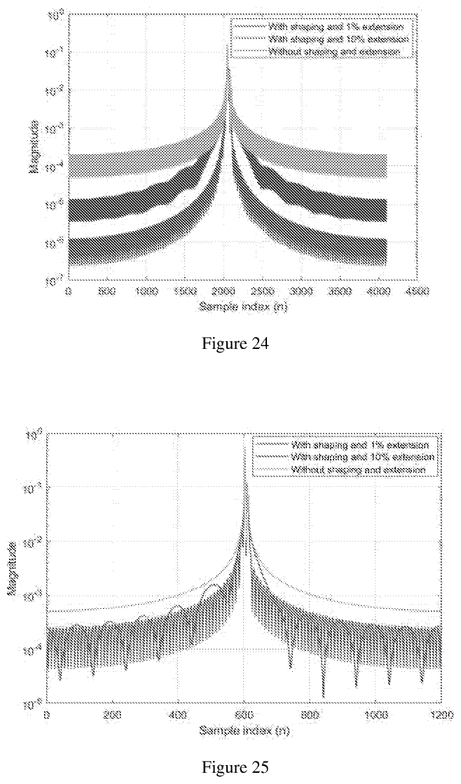

FIGS. 24 and 25 shows the effective time domain channel after the CP removal and post IDFT at the receiver for TDL-C 100 nsec channel. As shown in the figures the channel energy is getting concentrated at the mail lobe with increase in the spectrum shaping extension factor. Similarly, FIGS. 26, 27 shows the effective time domain channel after CP removal and post IDFT at the receiver for TDL-C 300 nsec channel. Since TDL-C 300 nsec channel has more delay spread resulting in a greater number of timed domain dominant taps, more RS samples will be needed to estimate the channel with minimal error compared to the lower delay spread channels like TDL-C 100. In FIG. 27, with increase in the spectrum extension factor, the energy gets into the mail lobe.

The number of channel taps that needs to be collected should bring the power of the ISI taps as low as possible, which may depend on the modulation order. For lower modulation orders, system may function even with higher ISI power. However, for higher modulation orders, ISI power from the excluded channel taps should be low for system to function. Hence, for Higher modulation order, the length of taps to be collected should be more. The length of RS depends on the number of taps that needs to collected. Hence, the RS size is modulation dependent and the number of taps to be collected. For example, from FIG. 25, which is the effective time domain channel on the allocated symbol for TDL-C 100 nsec, to operate the system less than −30 dB ISI about 150 RS samples with 10% extension may be needed, while to decrease the ISI power to less than 40 dB about 300 RS samples may be needed for channel estimation. Similarly, the length of each CP (post-fix and pre-fix) may be around half of the RS size that is used for estimation. This may ensure better channel estimation.

Similar to BLER performance analysis in Delay AWGN channel, BLER performance analysis of “pre-DFT RS and data multiplexing with spectrum shaping and extension” have been performed in TDL channels. Both LOS and NLOS channel with different delay spreads are considered for BLER analysis, where TDL-C is NLOS, and TDL-E is LOS. The number of channel taps in any channel model depends on the delay spread of the channel, higher the delay spread, higher will be the number of channel taps. Similarly, in TDL channel models, the number of channel taps depends on the delay spread. If the delay spread is high, a greater number of RS samples will be needed to estimate the channel. Additionally, with larger delay spreads, there is possibility of more number of tones in deep null, which eventually deteriorates the BLER performance. Hence, in single receive antenna TDL-C case, with the increase in the normalized delay spread from 100 nsec to 300 nsec, there is deterioration of BLER performance. However, with two receive antennas the performance with both the delay spreads are almost same. FIGS. 28, 29 shows the BLER performance of proposed system in TDL-C channel. Similarly, BLER performance for TDL-E 100 nsec for 1, and 2 receive antennas is shown in FIG. 31.

FIG. 30 shows the BLER performance of proposed system in NLOS channel with different FFT sizes. The transmitter allocation size and the RS, CP allocations size are kept same across different FFT sizes. The effective time-domain channel on the received symbol post IDFT is given by the equation:

$$\tilde{h} ( {n}^{′} ) = {\sum }_{n = 0}^{L - 1} h ( n ) {\sum }_{k = 0}^{M - 1} {e}^{j 2 π k ( \frac{{n}^{′}}{M} - \frac{n}{N} )}$$

Where, L is the number of channel taps. M is the subcarriers allocated to the transmitter. N is the FFT size. Here, with the increase in the FFT size (N), the effective number of taps (L) of the channel also increases. Hence, the energy of the channel for a given allocation for different FFT sizes will be same. This results in similar BLER performance irrespective of the FFT sizes.

FIG. 32 compares the BLER performance of the proposed system with SQRC shaping and oversampled GMSK pulse. Compared to the frequency response of the SQRC pulse, major taps of the LGMSK pulse have magnitude less than 1. Hence, when such kind of filter is used for shaping the symbol, there will be increment in the noise power on equalized data. Therefore, the performance with SQRC shaping is better compared to the oversampled GMSK pulse.

FIG. 33 shows the performance of the proposed system with pi/2-BPSK modulation without any spectral extension. Here, pi/2-BPSK modulation is modified version of BPSK modulation which has maximum separated distance between the modulated symbols. Hence, even without any spectral extension, there is no error floor in BLER performance. In this method, 2-tap filter [1 1]/sqrt (2), obtained from oversampling LGMSK pulse is used to get the frequency response of the spectrum shaping filter.

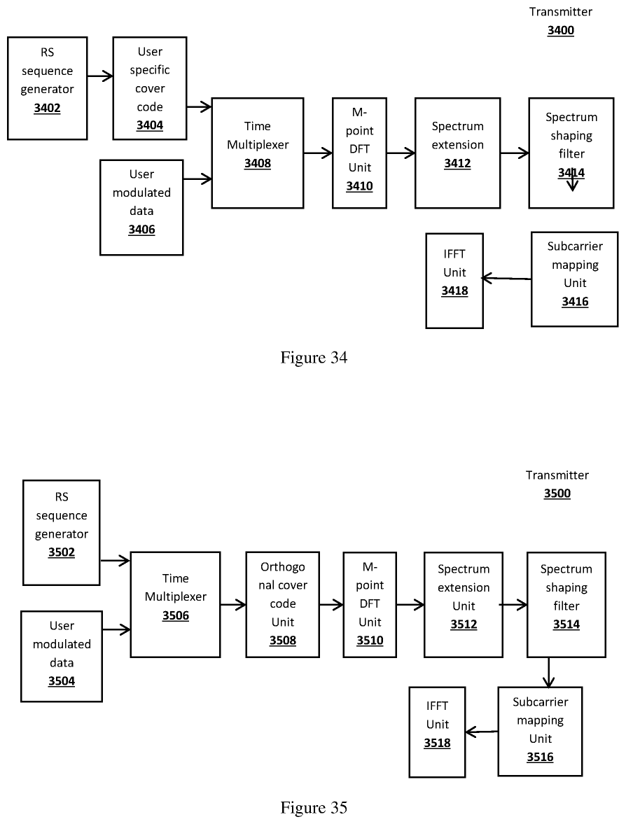

One embodiment of the present disclosure is multiple input multiple output (MIMO) transmission. FIG. 34 shows a block diagram of a Transmitter for Data and RS multiplexed in one OFDM symbol and multi-transmitter, with spectrum shaping and excess bandwidth.

The transmitter RS is repeated in time-domain multiplexed symbol as many times as the number of transmitters to be multiplexed in the symbol. On top of the repeated RS, an exponential

$${e}^{\frac{j 2 π n {δ}_{u}}{{N}_{r}}}$$

is multiplied for each transmitter, where δᵤ is transmitter specific/unique for each transmitter and chosen such that transmitters are orthogonal at the receiver for estimation, δᵤ∈{0, 1, 2, 3, 4, . . . }. The effective This helps in obtaining a comb like structure at the receiver in frequency domain (like FDM), which eventually helps in better channel estimation. RS is multiplexed with transmitter specific data in time domain to form pre-DFT-symbol. The position of RS of each transmitter may be in the center or starting or ending of the OFDM symbol, but the position should be same across all the transmitters. To support better channel estimation either pre-fix or post-fix or both pre-fix and post-fix will be added to the repeated RS in the time domain. The sequence to be used as RS is one of a pi/2-BPSK, QPSK, ZC, and CGS (computer generated sequences) sequence. The Frequency spectrum of RS could be flat to ensure unbiased channel estimation. The RS, CP may occupy a portion of resources allocated to the transmitter, which may depend on properties of channel conditions, Excess bandwidth, transmitter allocation size, modulation order, coding rate, and other parameters like impulse response of spectrum shaping filter, number of transmitters multiplexed.

In another method, same RS sequence is used for all the transmitters that are multiplexed. The position of RS is in the center or starting or ending of the OFDM symbol. To support better channel estimation either pre-fix or post-fix or both pre-fix and post-fix will be added to the repeated RS in the time domain. The sequence to be used as RS is one of a pi/2-BPSK, QPSK, or ZC, CGS (computer generated sequences) sequences. The Frequency spectrum of RS could be flat to ensure unbiased channel estimation. The RS, CP may occupy a portion of resources allocated to the transmitter, which may depend on properties of channel conditions, Excess bandwidth, transmitter allocation size, modulation order, coding rate, and other parameters like impulse response of spectrum shaping filter.

In another method, same RS sequence is used for all the transmitters that are multiplexed. The position of RS is in the center or starting or ending of the OFDM symbol. The RS samples are kept orthogonally for each transmitter by placing zeros in the position of RS in all the other transmitter symbols like in TDM. This ensures orthogonality across transmitter RS at the receiver post IDFT, which eventually results in better channel estimation. To support better channel estimation either RS-pre-fix or RS-post-fix or both RS-pre-fix and RS-post-fix will be added to the RS in the time domain. The sequence to be used as RS is one of a pi/2-BPSK, QPSK, CGS (computer generated sequences), and ZC sequence. The Frequency spectrum of RS could be flat to ensure unbiased channel estimation. The RS, RS-CP may occupy a portion of resources allocated to the transmitter, which may depend on properties of channel conditions, Excess bandwidth, transmitter allocation size, modulation order, coding rate, and other parameters like impulse response of spectrum shaping filter.

FIG. 35 shows a block diagram of a transmitter Pre-DFT RS data multiplexing with spectrum extension and shaping for multi-transmitter with OCC in frequency domain.

The RS sequence of each transmitter may be cyclic shifts of a base sequence or cyclic shifts of sequence of another transmitter. The RS of each transmitter is applied with an orthogonal cover code in time domain or in frequency domain. The sequence is one of a pi/2-BPSK, QPSK, CGS (computer generated sequences), and ZC sequence.

The transmitter data contains pi/2-BPSK, QPSK, QAM, or PAM modulation symbols. The data is either related to control messages like ACK/NACK, CQI or transmitter specific information. In an embodiment of the present disclosure, the data and RS are time multiplexed. The multiplexed symbol is represented by x′(n), where n=0, 1, . . . , M−1. DFT precoding is applied on the resultant multiplexed symbol through an M sized DFT.

$$X ( k ) = \frac{1}{\sqrt{M}} {\sum }_{n = 0}^{M - 1} {x}^{′} ( n ) {e}^{- \frac{j 2 π k n}{M}}$$

It is to be noted that, to maintain the PAPR, when the transmitter data is pi/2-BPSK modulated, then pi/2-BPSK based reference sequences has to be used, so that phase continuity is maintained between the RS and transmitter pi/2-BPSK data. Spectrum extension is performed on the DFT pre-coded symbol, last d/2 samples of the pre-coded data are copied and placed at the beginning of the symbol as pre-fix and then the initial d/2 samples of the pre-coded data are copied and placed at the end of the symbol as post-fix, where d is the spectrum extension factor. This results in an OFDM symbol of size M+d, which is represented as,

$${X}_{exs} ( k ) = X ( ( k - \frac{d}{2} ) mod M )$$

Or the spectrum extension operation may be performed as below

$${X}_{exs} ( k ) = X ( ( k - K ) mod M )$$

where, k=0, 1, . . . , M+d−1, K may be some known shift or arbitrary shift which is a function of the allocation M. Where, k=0, 1, . . . , M+d−1. The additional bandwidth that needs to be used for spectrum extension is indicated to the UE by the base station. Base station may indicate either extension on one side of the allocated bandwidth or two sides of the allocated bandwidth in steps of half PRB or one PRB. The signaling of the excess bandwidth may be done as a part of resource allocation. The Bandwidth extension on either side of the allocated bandwidth may be almost equal such that the spectrum shaping filter is symmetric. The spectrum extension may be asymmetric also, which means, the additional bandwidth on each side of the allocated bandwidth may be of different sizes. Alternatively, the gNB may indicate the transmitter 2 parameters-usable BW where data is allocated and excess BW where shaping is allowed. The gNB scheduler may take care of these 2 parameters per UE as part of the entire scheduling operations. The excess BW when symmetric is assumed to have equal guard subcarriers on either side of the allocated spectrum. However, for asymmetric cases, an additional parameter which indicates the start location of the usable BW is indicated between UE and gNB. The spectrum extension factor depends on channel properties, allocation size, modulation order, coding rate, and RS, RS-CP lengths. Pi/2-BPSK modulation is a special case, where spectrum extension may not be needed. Spectrum shaping is performed on the spectrum extended data by multiplying with the frequency response of the spectrum shaping filter. The spectrum shaped data is represented as,

$${X}_{ss} ( k ) = W ( k ) {X}_{exs} ( k )$$

The filter W(k) is a frequency response of square root raise cosine, raised cosine, Hanning, Blackman or Hamming windows, or the filter which is an oversampled Linearized Gaussian Minimal Shifting Keying (LGMSK) pulse. Otherwise, the filter W(k) is a square root of the frequency response of the above-mentioned filters. The spectrum shaping filter is either specified by the base station or may be unknown at the base station. The spectrum shaping filter may be RAN1 specified or specification transparent.

When spectrum extension factor ‘d’ is zero, no spectrum extension is performed, for example modulation schemes like pi/2-BPSK. In this case, spectrum shaping is performed either in time-domain by circular convolving the data-RS multiplexed symbol with impulse response of the spectrum shaping filter or in frequency domain, where the DFT-pre-coded symbol is simply multiplied with the frequency response of the spectrum shaping filter. The spectrum shaping help in reduction of PAPR, which eventually results in better power efficiency. Spectrum shaped data is mapped on to the subcarriers allocated to the transmitter, followed by an IFFT of size N to generate an OFDM waveform. The OFDM waveform is operated with phase compensation after CP addition.

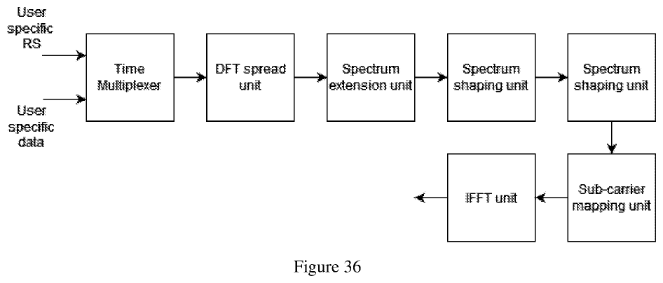

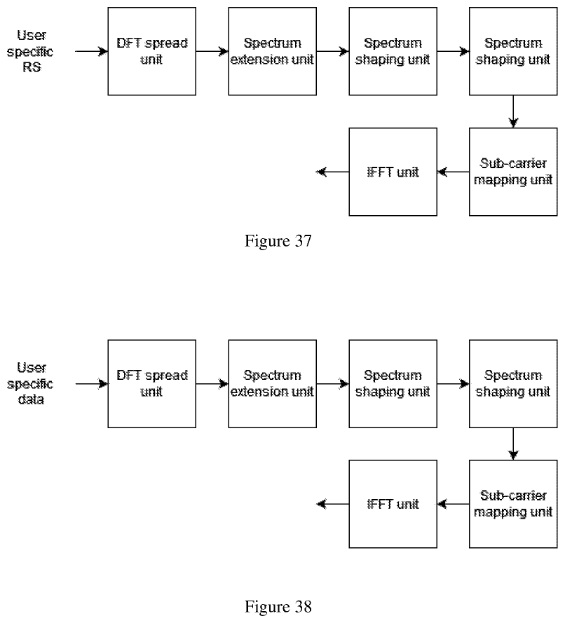

FIG. 36 shows the block diagram of transmitter for multiplexing RS and data for a transmitter. The RS specific to the transmitter is generated using one of the ways mentioned above. In the absence of data, only RS is transmitted in the OFDM symbol using similar technique as in FIG. 37. In this case, only RS is DFT precoded and cyclically extended to apply the spectrum shaping. The spectrum shaped data is mapped and sent to IFFT, CP addition, phase compensation and front end processing units before transmission. FIG. 37 shows the transmitter block diagram for the proposed system without any data. This kind of transmission is filtered-extended bandwidth shaped full RS DFT-s-OFDM symbol.

In the absence of RS, only data is transmitted in the OFDM symbol using similar technique as in FIG. 38. In this case, only data is DFT precoded and cyclically extended to apply the spectrum shaping. The spectrum shaped data is mapped and sent to IFFT, CP addition, phase compensation and front end processing units before transmission. FIG. 38 shows the transmitter block diagram for the proposed system without any RS. This kind of transmission is filtered-extended bandwidth shaped full data DFT-s-OFDM symbol.

In an embodiment, the multiplexed pilots with the data are referred as data streams. The data streams may be configured to be transmitted over one or more corresponding channels. For every channel, one or more antennas may be used. Thus, for every channel, a DFT-s-OFDM symbol is generated. Each multiplexed symbol may be mapped to one or more transmitters.

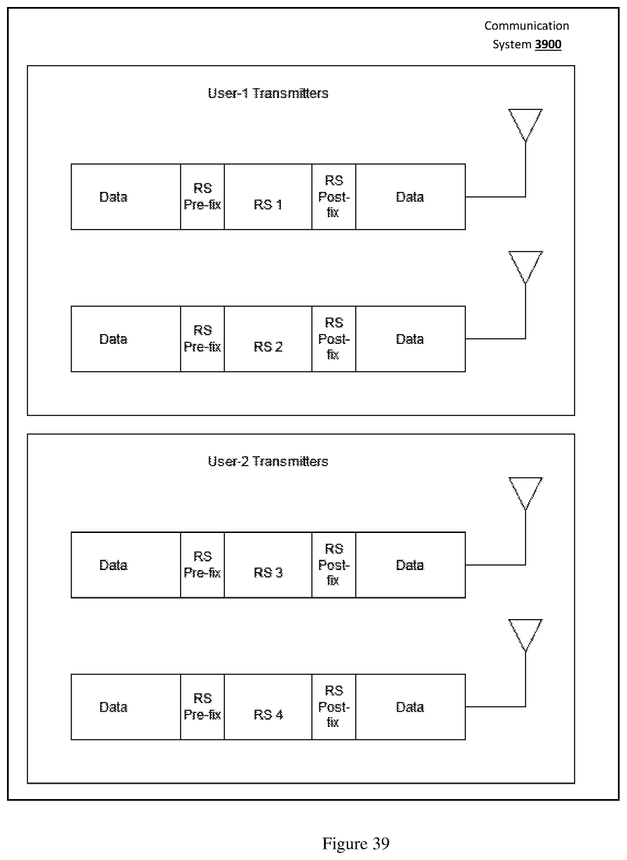

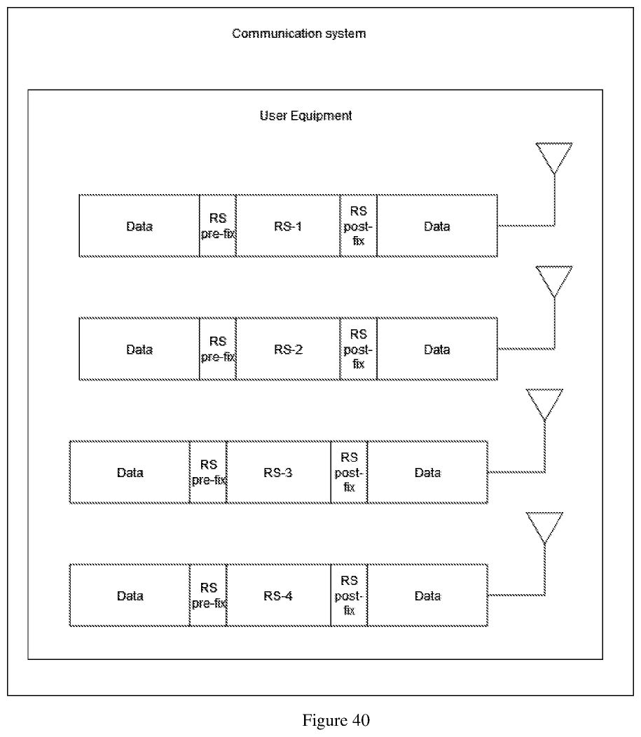

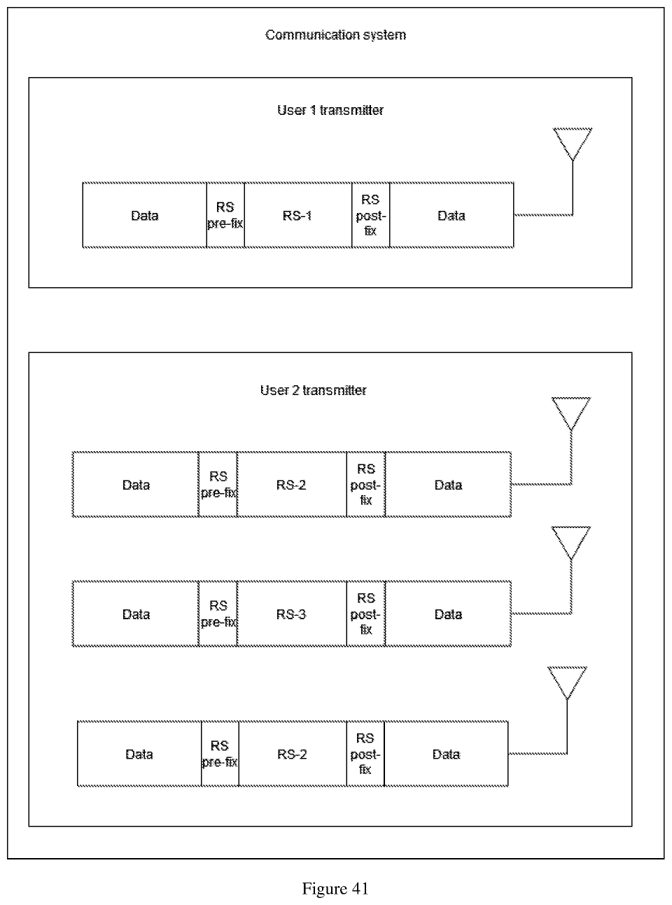

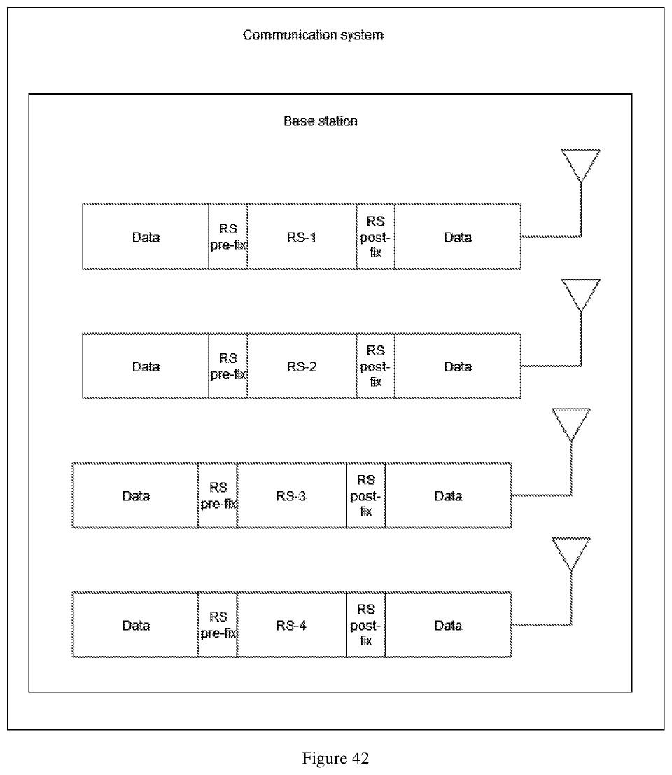

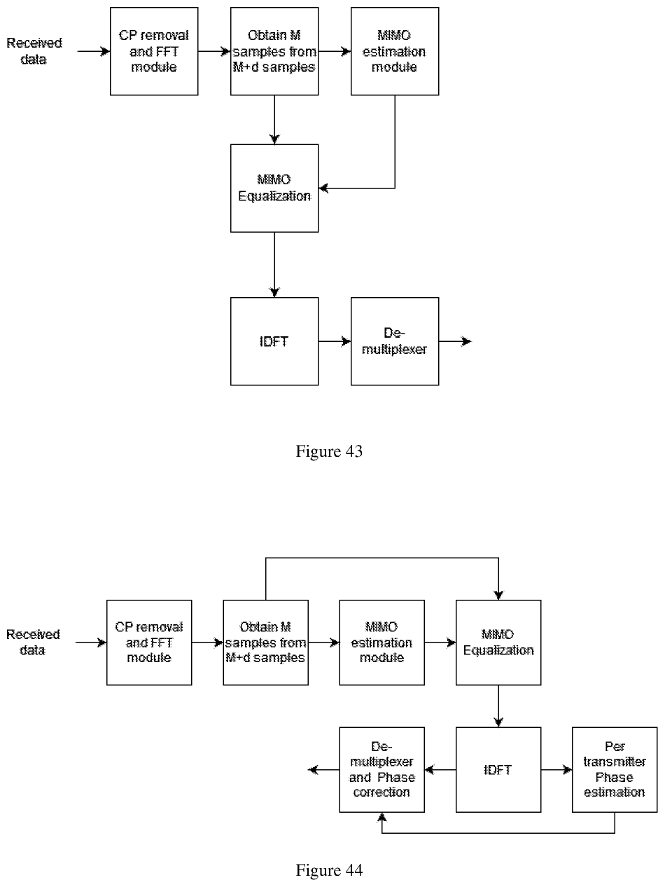

In an embodiment, each multiplexed symbol may be mapped to each separate transmitter, where the transmitters may be from a single user or single base station or plurality of users and plurality of base stations. FIGS. 39 to 42 shows the mapping of proposed symbol structure to transmitters. FIG. 39 is an illustration of mapping of two proposed symbol to two different antennas of one user and mapping of other two symbols to another user antenna. FIG. 40 shows an illustration of multiple transmitters at the same user equipment. FIG. 41 shows an illustration of a communication system where one of the two users has only one transmitter, while the other has three transmitters. FIG. 42 shows a communication system where one base station having multiple transmit antennas.

One embodiment of the present disclosure is a MIMO receiver. At the receiver, the received signal is first processed with front processing elements like ADC, CP removal, phase compensation and FFT. The allocated sub-carriers are de-mapped in the sub-carrier de-mapper, where M+d allocated sub-carriers are de-mapped from entire FFT output. If spectrum shaping performed at the transmitter is with square root of the frequency response of the spectrum shaping filter and filter is known at the receiver, then de-mapped “M+d” subcarriers are multiplied with the same filter used at the transmitter before further processing. This helps in maximizing the receiver SNR. If the filter is not known at the receiver, then the de-mapped data is processed without any receiver shaping. The filter used at the receiver is referred as a subcarrier filter. The subcarrier filter is one of SQRC, RC, Hanning, Hamming, Blackman, or LGMSK pulses, and square root of the above-mentioned pulses.

The spectrum shaping filter used by the transmitter and receiver are the same and is indicated (or pre-determined/a priori agreed) between the UE and BS. One example of such a filter is square root raised cosine pulse which is applied in the frequency domain (in both Tx and Rx sides).

From M+d size de-mapped data Y(k), M samples are obtained either by picking the central M samples or using one of the two identical methods by folding the spectrum. In the first method, M samples are obtained from M+d samples by taking modified IDFT of size M, which is expressed using the following equation:

$$\tilde{Y} ( k ) = \frac{1}{\sqrt{M}} {\sum }_{k = 0}^{M + d - 1} Y ( k ) {e}^{\frac{j 2 π ( k - \frac{d}{2} ) n}{M}}$$

The second method, which is equivalent to the above expression involves the following steps.

From the de-mapped data Y(k), central M-subcarriers are collected and labelled as Y₁(k).

The de-mapped data is left shifted by M-subcarriers to collect central M-subcarriers which is labelled as Y₂(k).

The de-mapped data is right shifted by M-subcarriers to collect central M-subcarriers which is labelled as Y₃(k).

Effective received data of size M is obtained by adding all the above collected data. The effective data is given by

$$\tilde{Y} ( k ) = {Y}_{1} ( k ) + {Y}_{2} ( k ) + {Y}_{3} ( k )$$

This procedure is encapsulated in the FIG. 14. An IDFT of size M is taken over the effective data \tilde{Y}(k) to obtain the received data in time-domain, where Data and RS are de-multiplexed. The received RS samples are used for channel estimation. Estimation may be performed by Least Squares method, or Least Squares followed by time-domain interpolation, or MMSE. Depending on the kind of orthogonality applied at the transmitter, estimation is performed such that, estimation of transmitter specific channel on each receiver antenna may be performed with less error. The estimated channel obtained from RS will be used for equalizing the de-mapped symbol of size M using an equalizer like WL-MMSE. An IDFT of size M is performed on each transmitter equalized data to obtain multiplexed RS and data in time-domain. Each transmitter data is de-multiplexed and sent for further processing. The receiver architecture for this is as shown in FIG. 43.

FIG. 43 shows a block diagram of a receiver multi-transmitter pre-DFT Data and RS multiplexed in one OFDM symbol, with spectrum shaping and excess bandwidth. In one embodiment, at the receiver, channel estimates of different transmitters are separated using one or more receiver filters. The filtered channel estimates are used to estimate the transmitter specific channel estimates. The size of each window depends on the length of the RS used at the transmission. If the multiplexed symbol has plurality of RS blocks, the main longest RS will be used for channel estimation. The other smaller RS will be used for phase tracking or Doppler tracking like described in FIG. 44.

In one embodiment, at the receiver, the received data is performed with least squares and the estimates of each transmitter is filtered in time domain using transmitter specific windows. The filtered transmitter specific time domain channel estimates are used to obtain final transmitter specific channel estimates. Expressions corresponding to the same is shown below.

The received data after de-mapping is

$${Y}_{{κ}^{=}} {\sum }_{i = 1}^{{N}_{t}} {P}_{k}^{i} {X}_{k}^{i} {H}_{k}^{i} + {W}^{i}$$

The recovered RS from Inverse Fourier transform of Yₖ is given by

$${y}_{r}^{i} ( n ) = {\sum }_{i = 1}^{{N}_{u}} {r}_{n}^{i} ⊙ {h}_{n}^{i} + {w}^{i}$$

$${y}_{r}^{i} = {R}_{1} {h}_{1}^{i} + {R}_{2} {h}_{2}^{i} + {R}_{3} {h}_{3}^{i} + {R}_{4} {h}_{4}^{i}$$

$${\hat{h}}^{i} = {R}_{1}^{*} {y}_{r}^{i}$$

$${\hat{h}}^{i} ( n ) = {h}_{1}^{i} ( n ) + {h}_{1}^{i} ( n - \frac{{N}_{r}}{2} ) + {h}_{1}^{i} ( n - \frac{{N}_{r}}{4} ) + {h}_{1}^{i} ( n - \frac{3 {N}_{r}}{4} )$$

On ĥⁱ(n), transmitter specific windows are applied to get the time domain channel estimates of each transmitter, which will be further used to obtain the final channel estimates of each transmitter.

In another embodiment, at the receiver, the RS of a transmitter is received on a specific index of the Fourier transform of yᵣⁱ(n), where yᵣⁱ(n) is the RS locations of the time domain received data. The estimate on the transmitter specific index is used to estimate the channel on the receiver. Let the data received on index k be Y(k). The channel in the index k is estimated using Y(k) and the Fourier transform of transmitted RS r(n).

$${H}_{i}^{R} ( k ) = \frac{Y ( k )}{ℱ ( r ( n ) )} or Y ( k ) \times conj ( ℱ ( r ( n ) ) )$$

The vector Hᵢ^{R}(n) is interpolated in time domain to obtain the final channel estimates for transmitter ‘i’.

In another embodiment, at the receiver, one of the transmitter RS may be used for phase estimation in the equalized data. Let the equalized data of transmitter ‘i’ which has RS be \hat{x}ᵢ(n), and one of the transmitted RS be xᵢ(n). The phase estimation is performed by

$${θ}_{i} ( n ) = {\hat{x}}_{i} ( n ) / {}_{i} x ( n )$$

where, n={0, 1, 2, 3 . . . N_r}, Nᵣ is the size of the RS used for phase estimation.

Final phase of transmitter ‘i’ may be estimated by averaging θᵢ(n). The final θᵢ^{avg} of transmitter ‘i’ may be used to phase correct the equalized data \hat{x}ᵢ(n) by \hat{x}ᵢ^{p}=\hat{x}ᵢ(n)e^{-iθ}^{ᵢ}^{^{avg}}.

FIG. 44 shows a block diagram of a receiver for multi transmitter pre-DFT data and RS multiplexed in one OFDM symbol, with spectrum shaping and excess bandwidth, where, the smaller RS will be used for phase tracking or Doppler tracking.

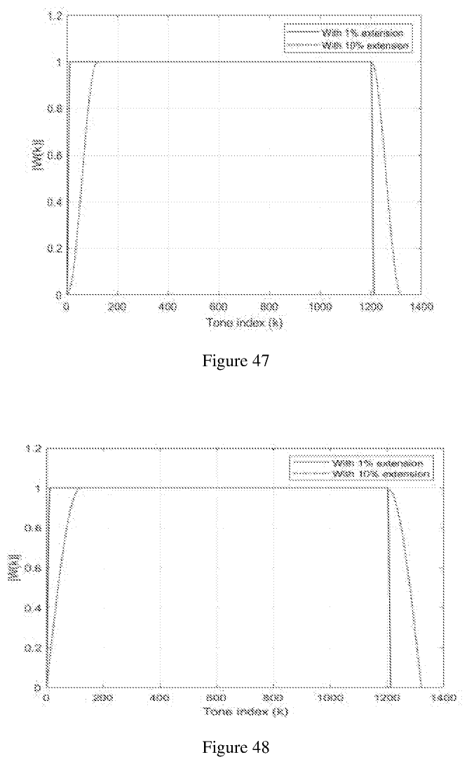

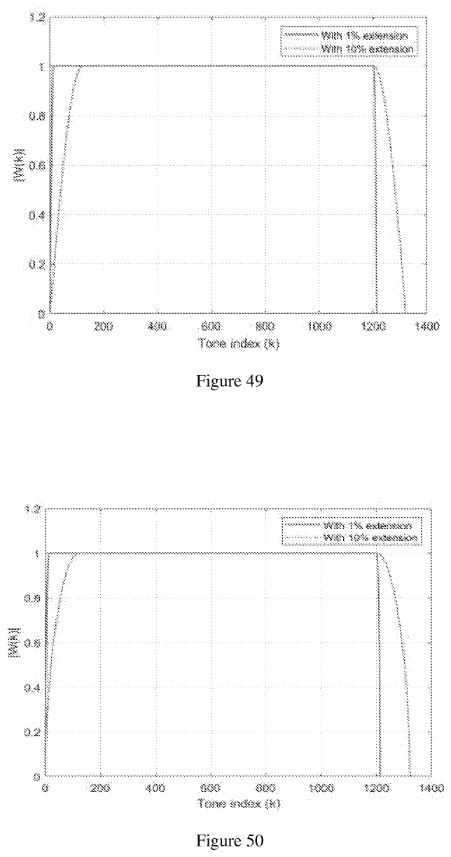

FIG. 45 shows a plot illustrating frequency response of 2-tap filter obtained from over sampling of LGMSK pulse. FIG. 46 shows a plot illustrating magnitude of square root of Frequency response of 2-tap filter obtained from over sampling of LGMSK pulse. FIG. 47 shows a plot illustrating frequency response of raised cosine pulse. FIG. 48 shows a plot illustrating magnitude of square root of frequency response of raised cosine pulse. FIG. 49 shows a plot illustrating frequency response of square root raised cosine pulse. FIG. 50 shows a plot illustrating magnitude of square root of frequency response of square root raised cosine pulse.

FIGS. 51C, 51D and 51E shows illustration of various OFDM symbols in a slot, in accordance with an embodiment of the present disclosure. FIGS. 51C and 51D shows the symbol structures for transmission in a slot. FIG. 51C shows illustration symbol structures, where at least one symbol has at least one large sized RS either with post-fix, or pre-fix or both pre-fix and post fix, along with at least one small sized RS block. The other symbols in the proposed slot structure may have symbols with at least one small sized RS blocks, as shown in FIG. 51D.

FIG. 51E shows illustration of symbol structures where, at least one symbol has at least one large sized RS either with post-fix, or pre-fix or both pre-fix and post-fix, and at least one small sized RS block. The other symbols in this structure may or may not have RS blocks in it. Hence, with the waveform structure of present disclosure, the symbols in a slot is a plain DFT-s-OFDM symbol carrying either RS or data, or DFT-s-OFDM with at least one smaller RS block for phase tracking, or DFT-s-OFDM symbol with at least one smaller RS block or at least one larger RS block. The smaller RS block and larger RS block may have either post-fix, or pre-fix, or both pre-fix and post-fix.

In an embodiment, a density of filtered-bandwidth extended DFT-s-OFDM symbol comprising RS and data depends on the operating SNR or Doppler shift between a transmitter and a receiver. Also, the density of filtered-bandwidth extended DFT-s-OFDM symbol comprising only RS depends on the operating SNR or Doppler shift between transmitter and receiver.

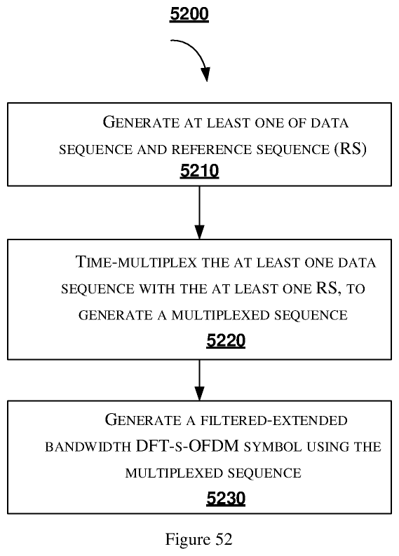

FIG. 52 shows a flowchart illustrating a method for transmitting a waveform in a communication network, in accordance with some embodiments of the present disclosure.

As illustrated in FIG. 52, the method 5200 comprises one or more blocks for transmitting a waveform. The method 5200 may be described in the general context of computer executable instructions. Generally, computer executable instructions can include routines, programs, objects, components, data structures, procedures, modules, and functions, which perform functions or implement abstract data types.

The order in which the method 5200 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 5210, generating, by a transmitter, at least one data sequence and at least one reference sequence (RS). The at least one data sequence is one of a pi/2 binary phase shift keying (BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence. In an embodiment, the at least one data sequence includes at least one of a user data and a control information. Each of the at least one data sequence includes at least one data, and at least one of a data cyclic prefix and a data cyclic suffix.

The at least one RS comprises one or more transmitter specific RS repetitions associated with each of the one or more transmitters. In an embodiment, each of the plurality of transmitter specific RS is multiplied with a transmitter specific code cover. The transmitter specific code cover is a sample based code cover. In another embodiment, the transmitter specific code cover is a RS based code cover. The transmitter specific code covers are orthogonal to each other. The transmitter specific code cover is one of a binary phase shift keying (BPSK) sequence, an exponential sequence a Walsh Hadamard sequence, PN sequences and DFT sequence. Examples of DFT sequences are [1−1], [1−1−j 1], [−1 1], [1−1 1−1], [1 j−j 1]. Here j=\sqrt{−1}. In an embodiment, the transmitter specific code cover is dependent on a transmitter specific RS antenna port. Each of the one or more transmitter specific RS is cyclic shifted sequence of a base sequence.

The at least one RS is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence. In an embodiment, each of the at least one RS sequence includes at least one RS, at least one of a RS cyclic prefix and a RS cyclic suffix, size of the RS cyclic prefix is one of at least half of the RS size and an arbitrary value, size of the RS cyclic suffix is one of at least half of the RS size and an arbitrary value

At block 5220, time-multiplexing is performed for the at least one data sequence with the at least one RS, to generate a multiplexed sequence. The extended bandwidth (BW) symbol generator generates a filtered-extended bandwidth DFT-s-OFDM symbol using the multiplexed sequence. In an embodiment, the filtered-extended bandwidth DFT-s-OFDM symbol includes a plurality of RS, wherein size of the plurality of RS is different. In an embodiment, the filtered-extended bandwidth DFT-s-OFDM symbol includes a plurality of RS, wherein the size of the plurality of RS is same.

At block 5230, a filtered-extended bandwidth DFT-s-OFDM full RS symbol is generated for the multiplexed sequence comprising of at least one RS sequence. Similarly, a filtered-extended bandwidth DFT-s-OFDM full data symbol is generated for the multiplexed sequence comprising of at least one data sequence. In an embodiment, a filtered-extended bandwidth DFT-s-OFDM full RS symbol is generated for the multiplexed sequence comprising of at least one RS sequence. Similarly, a filtered-extended bandwidth DFT-s-OFDM full data symbol is generated for the multiplexed sequence comprising of at least one data sequence.

The advantages of the “a filtered-extended bandwidth DFT-s-OFDM symbol” signal are:
The spectrum shaping of excess BW reduces the PAPR and increases the overall transmission power
Multiple RS blocks can be multiplexed to track the channel. In one embodiment, a “long RS block” can be used to the estimate the overall channel impulse response and “short RS blocks” (including single pilot) can be distributed over the span of the symbol to track the phase changes. Alternatively, multiple RS blocks of equal length can be used to estimate the channel locally and equalize the adjacent data blocks.

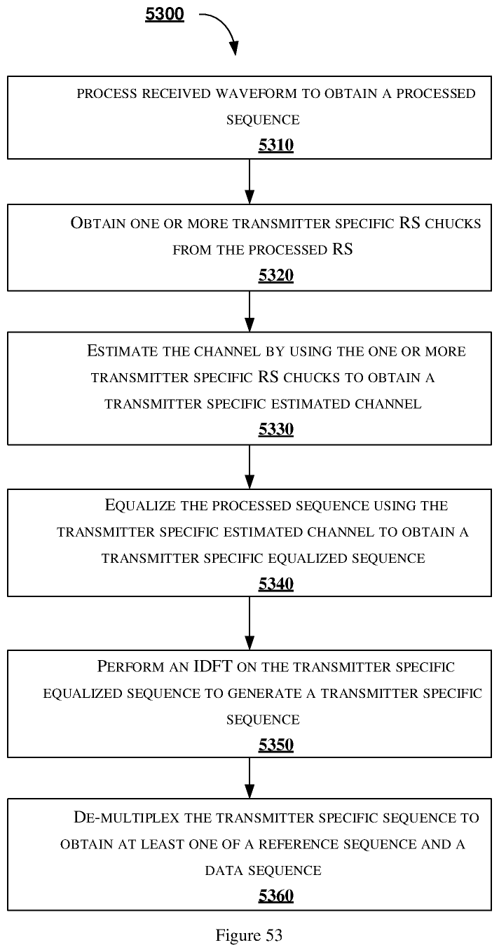

FIG. 53 shows a flowchart illustrating a method for receiving a waveform in a communication network, in accordance with some embodiments of the present disclosure.

As illustrated in FIG. 53, the method 5300 comprises one or more blocks for receiving a waveform. The method 5300 may be described in the general context of computer executable instructions. Generally, computer executable instructions can include routines, programs, objects, components, data structures, procedures, modules, and functions, which perform functions or implement abstract data types.

The order in which the method 5300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 5310, processing, by a receiver, the received waveform by performing one of coherently adding an extended bandwidth and removal of an extended bandwidth from the received waveform, to obtain a processed sequence. The received waveform is in a slot, said slot comprises a plurality of OFDM symbols, said plurality of OFDM symbols includes at least one of a at least one filtered-extended bandwidth DFT-s-OFDM symbol comprising of RS and data, at least one filtered-extended bandwidth DFT-s-OFDM symbol comprising of full RS, and at least one filtered-extended bandwidth DFT-s-OFDM symbol comprising of full data. The processing depends on at least one of a RS cyclic prefix and a RS cyclic suffix, in an embodiment of the present disclosure.

At block 5320, obtaining one or more transmitter specific RS chucks from the processed sequence.

At block 5330, estimating the channel by using the one or more transmitter specific RS chucks based on an estimation method to obtain a transmitter specific estimated channel. The channel estimation is performed using at least one reference sequence (RS) in the received waveform, wherein the channel estimation is used to detect at least one of a data and a control sequence of interest.

At block 5340, equalizing the extended bandwidth sequence using the transmitter specific estimated channel to obtain a transmitter specific equalized sequence. The receiver uses at least one of: one or more filtered-extended bandwidth DFT-s-OFDM full RS symbols, one or more filtered-extended bandwidth DFT-s-OFDM symbol comprising RS sequence and a data sequence for channel estimation and equalization.

In an embodiment, the receiver uses at least one of: one or more filtered-extended bandwidth DFT-s-OFDM full RS symbols, one or more filtered-extended bandwidth DFT-s-OFDM symbols comprising at least one RS and at least one data sequence for phase tracking.

In an embodiment, the receiver uses at least one of: one or more filtered-extended bandwidth DFT-s-OFDM RS symbols, one or more filtered-extended bandwidth DFT-s-OFDM symbol comprising at least one RS and at least one data sequence for channel tracking over time and equalization of data using tracked channel. The subcarrier filter is an arbitrary chosen filter or match to the shaping filter used in the transmitter.

At block 5350, performing an Inverse Discrete Fourier Transform (IDFT) on the transmitter specific equalized sequence to generate a time domain transmitter specific sequence.

At block 5360, de-multiplexing the time domain transmitter specific sequence to obtain at least one of a reference sequence and a data sequence.

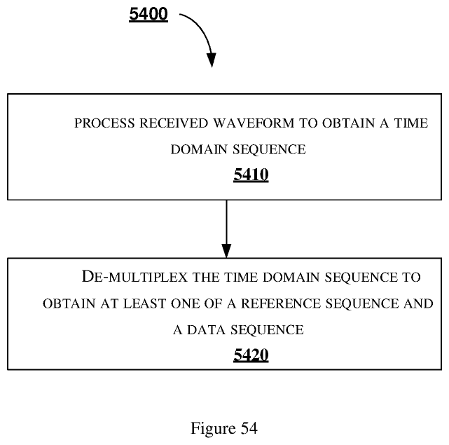

FIG. 54 shows a flowchart illustrating a method for receiving a waveform in a communication network, in accordance with some embodiments of the present disclosure.

As illustrated in FIG. 54, the method 5400 comprises one or more blocks for receiving a waveform. The method 5400 may be described in the general context of computer executable instructions. Generally, computer executable instructions can include routines, programs, objects, components, data structures, procedures, modules, and functions, which perform functions or implement abstract data types.

The order in which the method 5400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 5410, processing, by a receiver, the received waveform to obtain a time domain sequence. The processing of the received waveform comprises performing one of coherently adding an extended bandwidth and removal of an extended bandwidth from the received waveform, to obtain a processed sequence. The received waveform is in a slot structure, or referred as slot, comprising a plurality of OFDM symbols. The plurality of OFDM symbols includes at least one of a at least one filtered-extended bandwidth DFT-s-OFDM symbol comprising of RS and data, at least one filtered-extended bandwidth DFT-s-OFDM symbol comprising of full RS, and at least one filtered-extended bandwidth DFT-s-OFDM symbol comprising of full data. The processing depends on at least one of a RS cyclic prefix and a RS cyclic suffix, in an embodiment of the present disclosure.

Also, the processing comprises obtaining one or more transmitter specific reference sequences (RSs) by performing de-multiplexing operation on the processed sequence, and estimating the channel by using the one or more transmitter specific RS based on an estimation method to obtain a transmitter specific estimated channel. The channel estimation is performed using at least one reference sequence (RS) in the received waveform, wherein the channel estimation is used to detect at least one of a data and a control sequence of interest.

Further, the processing comprises equalizing the processed sequence using the transmitter specific estimated channel to obtain a transmitter specific equalized sequence and performing an Inverse Discrete Fourier Transform (IDFT) on the transmitter specific equalized sequence to generate a time domain sequence. The receiver uses at least one of: one or more filtered-extended bandwidth DFT-s-OFDM full RS symbols, one or more filtered-extended bandwidth DFT-s-OFDM symbol comprising RS sequence and a data sequence for channel estimation and equalization.

At block 5420, de-multiplexing the time domain sequence to obtain at least one of a reference sequence and a data sequence.

In an embodiment, the receiver uses at least one of: one or more filtered-extended bandwidth DFT-s-OFDM full RS symbols, one or more filtered-extended bandwidth DFT-s-OFDM symbols comprising at least one RS and at least one data sequence for phase tracking.

In an embodiment, the receiver uses at least one of: one or more filtered-extended bandwidth DFT-s-OFDM RS symbols, one or more filtered-extended bandwidth DFT-s-OFDM symbol comprising at least one RS and at least one data sequence for channel tracking over time and equalization of data using tracked channel. The subcarrier filter is an arbitrary chosen filter or match to the shaping filter used in the transmitter.

Another embodiment of the present disclosure is method for transmitting a slot. The slot comprising a plurality of OFDM symbols, said plurality of OFDM symbols includes at least one of: at least one filtered-extended bandwidth DFT-s-OFDM symbol comprising of RS and data at least one filtered-extended bandwidth DFT-s-OFDM symbol comprising of full RS, and at least one filtered-extended bandwidth DFT-s-OFDM symbol comprising of full data. The plurality of OFDM symbols includes at least one of a filtered-extended bandwidth DFT-s-OFDM symbol comprising of RS and data is filtered using a first filter, filtered-extended bandwidth DFT-s-OFDM symbol comprising of RS is filtered using a second filter, filtered-extended bandwidth DFT-s-OFDM symbol is filtered using a third filter, said filter have one on one correspondence among each other. In an embodiment the said filters are the same, i.e. having same coefficients. In another embodiment, the said filters are different.

A description of an embodiment with several components in communication with each other does not imply that all such components are required. On the contrary a variety of optional components are described to illustrate the wide variety of possible embodiments of the invention.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention. While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for transmitting a waveform, comprising:
generating, by one or more transmitters, at least one data sequence and at least one reference sequence (RS);
time-multiplexing, by the one or more transmitters, the at least one data sequence with the at least one RS, to generate a multiplexed sequence; and
generating, by the one or more transmitters, a filtered-extended bandwidth DFT-s-OFDM symbol using the multiplexed sequence;
wherein the filtered-extended bandwidth DFT-s-OFDM symbol generated by the one or more transmitters is transmitted in an OFDM symbol.

2. The method as claimed in claim 1, wherein generating a filtered-extended bandwidth DFT-s-OFDM symbol using the multiplexed sequence comprising:
transforming the multiplexed sequence using a Discrete Fourier Transform (DFT) to generate a transformed multiplexed sequence;
performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence;
mapping the extended bandwidth transformed multiplexed sequence with at least one of localized and distributed subcarriers to generate a mapped extended bandwidth transformed multiplexed sequence;
shaping the mapped extended bandwidth transformed multiplexed sequence using a filter to obtain a shaped extended bandwidth transformed multiplexed sequence;
performing an Inverse Fast Fourier Transform (IFFT) on the shaped extended bandwidth transformed multiplexed sequence to produce a time domain sequence; and
processing the time domain sequence to generate the filtered-extended bandwidth DFT-s-OFDM symbol.

3. The method as claimed in claim 2, wherein value of the N1 is at least zero, and value of the N2 is at least zero.

4. The method as claimed in claim 2, wherein processing the time domain sequence to generate a filtered-extended bandwidth DFT-s-OFDM symbol comprises performing at least one of addition of symbol cyclic prefix, addition of symbol cyclic suffix, windowing, weighted with overlap and add operation (WOLA), bandwidth parts (BWP) rotation, additional time domain filtering, sampling rate conversion to match DAC rate and frequency shifting on the time domain waveform, to generate the filtered-extended bandwidth DFT-s-OFDM symbol.

5. The method as claimed in claim 1, wherein the at least one RS comprises one or more transmitter specific RS repetitions associated with each of the one or more transmitters.

6. The method as claimed in claim 5, wherein number of one or more transmitter specific RS repetitions is at least zero.

7. The method as claimed in claim 1, wherein a filtered-extended bandwidth DFT-s-OFDM full RS symbol is generated for the multiplexed sequence comprising of at least one RS sequence.

8. The method as claimed in claims 1- or 7, wherein the at least one reference sequence (RS) comprises at least one of a long RS and a phase tracking RS (PTRS), said long RS comprises one or more RSs with at least one of cyclic prefix (CP) and cyclic suffix (CS).

9. The method as claimed in claim 8, wherein the at least one RS comprise a plurality of samples, wherein at least one of the plurality of RS samples is multiplexed with the at least one data samples for a phase tracking.

10. The method as claimed in claim 8, wherein the at least one RS is multiplied with one or more transmitter specific code covers to obtain one or more transmitter specific RS.

11-47. (canceled)

48. A method for transmitting a slot, comprising:
a plurality of OFDM symbols, said plurality of OFDM symbols includes at least one of: at least one filtered-extended bandwidth DFT-s-OFDM symbol comprising of RS and data at least one filtered-extended bandwidth DFT-s-OFDM symbol comprising of full RS, and at least one filtered-extended bandwidth DFT-s-OFDM symbol comprising of full data.

49. The method as claimed in claim 48, wherein the plurality of OFDM symbols includes at least one of a filtered-extended bandwidth DFT-s-OFDM symbol comprising of RS and data is filtered using a first filter, filtered-extended bandwidth DFT-s-OFDM symbol comprising of RS is filtered using a second filter, filtered-extended bandwidth DFT-s-OFDM symbol is filtered using a third filter, said filter have one on one correspondence among each other.

50. The method as claimed in claim 49, wherein said filters are the same.

51. A method for receiving a waveform, the method comprising,
processing, by a receiver, the received waveform to obtain a time domain sequence; and
de-multiplexing, by the receiver, the time domain sequence to obtain at least one of a reference sequence and a data sequence.

52. The method as claimed in claim 51, wherein the processing the received waveform comprising:
performing one of coherently adding an extended bandwidth and removal of an extended bandwidth from the received waveform, to obtain a processed sequence obtaining one or more transmitter specific reference sequences (RSs) by performing demultiplexing operation on the processed sequence;
estimating the channel by using the one or more transmitter specific RS based on an estimation method to obtain a transmitter specific estimated channel;
equalizing the processed sequence using the transmitter specific estimated channel to obtain a transmitter specific equalized sequence; and
performing an Inverse Discrete Fourier Transform (IDFT) on the transmitter specific equalized sequence to generate a time domain sequence.

53. The method as claimed in claim 51, wherein the one or more transmitter specific RSs comprises at least one of a long RS, said long RS comprises one or more RSs with at least one of cyclic prefix (CP) and cyclic suffix (CS).

54. The method as claimed in claim 52, wherein the one or more RSs is one of a localized set of samples and a distributed set of samples.

55. The method as claimed in claim 52, wherein the at least one of the CP and the CS of one or more long RS is used for phase tracking or estimation.

56. The method as claimed in claim 51, wherein the processed sequence comprises at least one of a long RS and a PTRS, said PTRS is at least one sample multiplexed with at least one data sample.

57. The method as claimed in claim 51, wherein the method comprises performing phase tracking operation on the processed sequence using the PTRS.

58-64. (canceled)
